(19) United States
(12) Patent Application Publication
(10) Pub. No.: US 2026/0154242 A1
(43) Pub. Date: Jun. 4, 2026

(54) APPARATUSES, SYSTEMS, AND COMPUTER PROGRAM PRODUCTS FOR ASSESSING PERFORMANCE OF A DATA ARCHITECTURE MODEL VIA AN AUTOMATED COMPARISON FRAMEWORK

(71) Applicant: Atlassian US, Inc., San Francisco, CA (US)

(72) Inventors: Batuhan Kama, Ankara (TR); Berat Gümüs, Izmir (TR); Berke Tezergil, Ankara (TR); Fatma Sirin Koru, Ankara (TR)

(21) Appl. No.: 18/966,974

(22) Filed: Dec. 3, 2024

(51) Int. Cl. G06F 16/21; G06F 11/34

(52) U.S. Cl. CPC G06F 16/212; G06F 11/3409

(57) ABSTRACT

Methods, apparatuses, or computer program products provide for assessing performance of a data architecture model via an automated comparison framework. In some examples, techniques disclosed herein include receiving a first structured data object generated by a first data architecture model, receiving a second structured data object generated by a second data architecture model, executing a comparison of the first structured data object generated by the first data architecture model and the second structured data object generated by the second data architecture model, generating, based at least in part on the comparison of the first structured data object and the second structured data object, performance monitoring data associated with the second data architecture model, and refining the second data architecture model based at least in part on the performance monitoring data.

### BACKGROUND

It is often difficult to manage and/or support components of a server system in which inputs and/or components of the server system dynamically change. Moreover, transitioning an architecture of a server system from one data architecture model to another data architecture model in a manner which minimizes downtime and/or performance degradation of the server system and/or components of the server system is especially difficult. Through applied effort, ingenuity, and innovation, these identified deficiencies and problems have been solved by developing solutions that are configured in accordance with the embodiments of the present disclosure, many examples of which are described in detail herein.

### BRIEF SUMMARY

Various embodiments described herein related to apparatuses, systems, and methods for assessing performance of a data architecture model via an automated comparison framework.

In accordance with some embodiments of the present disclosure, an example apparatus includes one or more processors and one or more storage devices storing instructions that are operable, when executed by the one or more processors, to cause the one or more processors to receive a first structured data object generated by a first data architecture model. In some embodiments, the instructions are additionally or alternatively operable, when executed by the one or more processors, to cause the one or more processors to receive a second structured data object generated by a second data architecture model. In some embodiments, the instructions are additionally or alternatively operable, when executed by the one or more processors, to cause the one or more processors to execute a comparison of the first structured data object generated by the first data architecture model and the second structured data object generated by the second data architecture model. In some embodiments, the instructions are additionally or alternatively operable, when executed by the one or more processors, to cause the one or more processors to generate, based at least in part on the comparison of the first structured data object and the second structured data object, performance monitoring data associated with the second data architecture model. In some embodiments, the performance monitoring data includes at least an indication of a type of discrepancy between the first structured data object and the second structured data object. In some embodiments, the instructions are additionally or alternatively operable, when executed by the one or more processors, to cause the one or more processors to refine the second data architecture model based at least in part on the performance monitoring data.

In some embodiments, the comparison is executed in response to the first structured data object and the second structured data object being received within a defined interval of time.

In some embodiments, the instructions are additionally or alternatively operable, when executed by the one or more processors, to cause the one or more processors to increase a value of a counter data object in response to (i) the first structured data object being received, (ii) the second structured data object being received, or (iii) the first structured data object and the second structured data object being received. In some embodiments, the instructions are additionally or alternatively operable, when executed by the one or more processors, to cause the one or more processors to execute the comparison of the first structured data object and the second structured data object in response to the value of the counter data object satisfying a defined threshold value.

In some embodiments, the instructions are additionally or alternatively operable, when executed by the one or more processors, to cause the one or more processors to receive an instruction data object associated with an application programming interface (API) request. In some embodiments, the instructions are additionally or alternatively operable, when executed by the one or more processors, to cause the one or more processors to transmit the instruction data object to the first data architecture model and the second data architecture model to cause (i) generation of the first structured data object via the first data architecture model and (ii) generation of the second structured data object via the second data architecture model.

In some embodiments, the instruction data object is received prior to the first structured data object and the second structured data object being received.

In some embodiments, the instructions are additionally or alternatively operable, when executed by the one or more processors, to cause the one or more processors to receive an instruction data object is response to a defined event associated with an application framework. In some embodiments, the instructions are additionally or alternatively operable, when executed by the one or more processors, to cause the one or more processors to transmit the instruction data object to the first data architecture model and the second data architecture model to cause (i) generation of the first structured data object via the first data architecture model and (ii) generation of the second structured data object via the second data architecture model.

In some embodiments, the first structured data object and the second structured data object include a web API Response, an internal API response, or an event-based notification response.

In some embodiments, the instructions are additionally or alternatively operable, when executed by the one or more processors, to cause the one or more processors to identify a performance failure event associated with the comparison of the first structured data object and the second structured data object. In some embodiments, the instructions are additionally or alternatively operable, when executed by the one or more processors, to cause the one or more processors to determine one or more performance failure patterns associated with the performance failure event. In some embodiments, the instructions are additionally or alternatively operable, when executed by the one or more processors, to cause the one or more processors to identify one or more features of the second data architecture model that impact the one or more performance failure patterns. In some embodiments, the instructions are additionally or alternatively operable, when executed by the one or more processors, to cause the one or more processors to refine the second data architecture model based at least in part on the one or more features.

In accordance with some embodiments of the present disclosure, a computer-implemented method is provided. In some embodiments, the computer-implemented method includes receiving a first structured data object generated by a first data architecture model. In some embodiments, the computer-implemented method additionally or alternatively includes receiving a second structured data object generated by a second data architecture model. In some embodiments, the computer-implemented method additionally or alternatively includes executing a comparison of the first structured data object generated by the first data architecture model and the second structured data object generated by the second data architecture model. In some embodiments, the computer-implemented method additionally or alternatively includes generating, based at least in part on the comparison of the first structured data object and the second structured data object, performance monitoring data associated with the second data architecture model. In some embodiments, the performance monitoring data includes at least an indication of a type of discrepancy between the first structured data object and the second structured data object. In some embodiments, the computer-implemented method additionally or alternatively includes refining the second data architecture model based at least in part on the performance monitoring data.

In some embodiments, the comparison is executed in response to the first structured data object and the second structured data object being received within a defined interval of time.

In some embodiments, the computer-implemented method additionally or alternatively includes increasing a value of a counter data object in response to (i) the first structured data object being received, (ii) the second structured data object being received, or (iii) the first structured data object and the second structured data object being received. In some embodiments, the computer-implemented method additionally or alternatively includes executing the comparison of the first structured data object and the second structured data object in response to the value of the counter data object satisfying a defined threshold value.

In some embodiments, the computer-implemented method additionally or alternatively includes receiving an instruction data object associated with an application programming interface (API) request. In some embodiments, the computer-implemented method additionally or alternatively includes transmitting the instruction data object to the first data architecture model and the second data architecture model to cause (i) generation of the first structured data object via the first data architecture model and (ii) generation of the second structured data object via the second data architecture model.

In some embodiments, the instruction data object is received prior to the first structured data object and the second structured data object being received.

In some embodiments, the computer-implemented method additionally or alternatively includes receiving an instruction data object is response to a defined event associated with an application framework. In some embodiments, the computer-implemented method additionally or alternatively includes transmitting the instruction data object to the first data architecture model and the second data architecture model to cause (i) generation of the first structured data object via the first data architecture model and (ii) generation of the second structured data object via the second data architecture model.

In some embodiments, the first structured data object and the second structured data object include a web API Response, an internal API response, or an event-based notification response.

In some embodiments, the computer-implemented method additionally or alternatively includes identifying a performance failure event associated with the comparison of the first structured data object and the second structured data object. In some embodiments, the computer-implemented method additionally or alternatively includes determining one or more performance failure patterns associated with the performance failure event. In some embodiments, the computer-implemented method additionally or alternatively includes identifying one or more features of the second data architecture model that impact the one or more performance failure patterns. In some embodiments, the computer-implemented method additionally or alternatively includes refining the second data architecture model based at least in part on the one or more features.

In accordance with some embodiments of the present disclosure, an example computer program product is provided. In some embodiments, the example computer program product includes at least one non-transitory computer-readable storage medium having computer-executable program code instructions stored therein. In some embodiments, the computer-executable program code instructions comprise program code instructions for receiving a first structured data object generated by a first data architecture model. In some embodiments, the computer-executable program code instructions additionally or alternatively include program code instructions for receiving a second structured data object generated by a second data architecture model. In some embodiments, the computer-executable program code instructions additionally or alternatively include program code instructions for executing a comparison of the first structured data object generated by the first data architecture model and the second structured data object generated by the second data architecture model. In some embodiments, the computer-executable program code instructions additionally or alternatively include program code instructions for generating, based at least in part on the comparison of the first structured data object and the second structured data object, performance monitoring data associated with the second data architecture model. In some embodiments, the performance monitoring data includes at least an indication of a type of discrepancy between the first structured data object and the second structured data object. In some embodiments, the computer-executable program code instructions additionally or alternatively include program code instructions for refining the second data architecture model based at least in part on the performance monitoring data.

In some embodiments, the computer-executable program code instructions additionally or alternatively include program code instructions for identifying a performance failure event associated with the comparison of the first structured data object and the second structured data object. In some embodiments, the computer-executable program code instructions additionally or alternatively include program code instructions for determining one or more performance failure patterns associated with the performance failure event. In some embodiments, the computer-executable program code instructions additionally or alternatively include program code instructions for identifying one or more features of the second data architecture model that impact the one or more performance failure patterns. In some embodiments, the computer-executable program code instructions additionally or alternatively include program code instructions for refining the second data architecture model based at least in part on the one or more features.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF SUMMARY OF THE DRAWINGS

Having thus described certain example embodiments of the present disclosure in general terms, reference will now be made to the accompanying drawings, which are not necessarily drawn to scale, and wherein:

FIG. 1 illustrates a block diagram of an example system within which one or more embodiments of the present disclosure may operate;

FIG. 2 illustrates a block diagram of another example system within which one or more embodiments of the present disclosure may operate;

FIG. 3 illustrates an example data flow for model refinement in accordance with one or more embodiments of the present disclosure.

FIG. 4 illustrates an example process for bidirectional replication in accordance with one or more embodiments of the present disclosure.

FIG. 5 illustrates an example data flow for synchronous response comparison in accordance with one or more embodiments of the present disclosure.

FIG. 6A illustrates an example data flow for asynchronous response comparison in accordance with one or more embodiments of the present disclosure.

FIG. 6B illustrates another example data flow for asynchronous response comparison in accordance with one or more embodiments of the present disclosure.

FIG. 7 illustrates an example process for synchronous response monitoring in accordance with one or more embodiments of the present disclosure.

FIG. 8 illustrates an example process for asynchronous response monitoring in accordance with one or more embodiments of the present disclosure.

FIG. 9A illustrates an example data flow between the automated comparison system and a data architecture model in accordance with one or more embodiments of the present disclosure.

FIG. 9B illustrates an example data flow between the automated comparison system and another data architecture model in accordance with one or more embodiments of the present disclosure.

FIG. 10 is a flowchart diagram of an example process for assessing performance of a data architecture model via an automated comparison framework in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

### Overview

Various embodiments of the present disclosure address technical problems associated with efficiently and reliably transitioning a server system from one data architecture model to another data architecture model in a manner which minimizes system downtime and/or maintains performance of the application framework. Data architecture transitions are a common practice for server systems and may occur for several reasons. For example, a data architecture transition may be desirable to improve quality, efficiency, and/or organization of a codebase for a server system. In another example, a data architecture transition may be desirable to update data architecture technologies of the server system and/or to take advantage of new hardware and/or for the server system. An example server system is an application framework. An application framework (e.g., a cloud application framework) is typically characterized by a large number of the application components (e.g., services, micro services, and the like) that are offered by the application framework. Those application components typically include a large number of frontend application components and/or a large number of backend application components. Additionally, the application framework may utilize one or more data architecture models to enable functionality of the application components. In various scenarios, it may be desirable to update a data architecture model of the application framework to improve performance and/or functionality of the application components.

Transitioning a server system from one data architecture model to another data architecture model typically results in simplified development, debugging, and maintenance processes, improved runtime and performance, improved data storage and security, increased scalability, and/or increased system reliability. However, integrating a new data architecture model into an existing system poses many technical challenges, such as compatibility and deployment issues, high development and maintenance costs, functionality regression, and increased system downtime. In some cases, transitioning to a new data architecture model may involve taking a server system offline while a new data architecture model is being deployed. Taking a server system offline prevents end users from accessing and using the server system, which is detrimental to performance and functionality of the server system when offline.

Moreover, once the new data architecture model has been deployed, compatibility issues and functionality regression must be addressed to ensure adequate performance of the application framework. For example, software system functions, hardware system functions, and/or machine learning models may not operate in the same manner as they did under the old data architecture model, causing the performance and reliability of the server system to suffer. Resolving these issues may require further development, testing, maintenance, and redeployment of a data architecture model, which requires significant computing resources, memory resources, and time to accomplish.

To address the above-described challenges related to transitioning from one data architecture model to another data architecture model, various embodiments of the present disclosure are directed to systems, apparatuses, methods, and/or computer program products for assessing performance of a data architecture model via an automated comparison framework. The automated comparison framework may utilize a data architecture comparison to compare performance of a new data architecture model for an application framework to an old data architecture model for the application framework. In various embodiments, the automated comparison framework may route instruction data objects (e.g., customer requests, API requests, etc.) to the old data architecture model and the new data architecture model simultaneously. Additionally, responses from the old data architecture model and the new data architecture model may be created. In various embodiments, responses from the old data architecture model may be transmitted to one or more client devices associated with the instruction data objects (e.g., to one or more users) while responses from the new data architecture model are assessed for performance criteria. In various embodiments, the automated comparison framework may be configured to compare responses from the old data architecture model and the new data architecture model to ensure accuracy of the response from the new data architecture model based on the performance criteria. In various embodiments, the automated comparison framework may generate one or more notifications, alerts, and/or performance resolution recommendations in response to a determination that there is a discrepancy between responses from the old data architecture model and the new data architecture model. In some embodiments, the automated comparison framework may compare the responses from the old data architecture model and the new data architecture model asynchronously.

The automated comparison framework may enable a seamless transition that minimizes alerts, incidents, performance degradation events, and/or user-reported issues related to an application framework while minimizing system downtime and/or providing improved performance for the application framework. In various embodiments, the automated comparison framework enables simplified development, debugging, and maintenance processes, improved runtime and performance, improved data storage and security, increased scalability, and/or increased system reliability for an application framework utilizing a new data architecture model. For the purposes of demonstration and clarity, the present disclosure may refer to an example transition from a data architecture model (e.g., a monolith data architecture model) to an enhanced data architecture model (e.g., a microservice data architecture model).

In various embodiments, the automated comparison framework is utilized during the development and testing of a new data architecture model to ensure that features and functions of the new microservice model produce the same correct outputs as the original data architecture model. As such, the likelihood that the data architecture model will experience functional regression upon its deployment to production may be reduced. In various embodiments, the automated comparison framework may replicate one or more actions and/or operations occurring the original data architecture model to confirm that the one or more actions and/or operations may be adequately performed via the new data architecture model. As a result of the action or operation, each model produces some form of output. The automated comparison framework may perform a data architecture comparison process to These outputs undergo a comprehensive comparison to determine whether respective outputs of the original data architecture model and the new data architecture model are equivalent. Making the determination that the two outputs are equivalent may indicate that the new data architecture model is operating correctly for the given function.

It is to be appreciated that these comparisons are complex and nuanced. For example, the comparison may be more complex and nuanced than a simple raw data comparison in order to accurately determine if two outputs are equivalent. Due to the differing and dynamic nature of the data architecture model and new data architecture model, outputs may differ in type, format, and organization of data, and/or may contain additional detail that may not be relevant to the purpose of the comparison. As such, in various embodiments, the automated comparison framework may utilize additional logical processing to determine if the relevant content of the two outputs is equivalent.

In various embodiments, the new data architecture model may be deployed in stages via the application framework. Deploying the new data architecture model in stages instead of all at once allows more reliable control over the deployment process, capitalizes on portions of the new data architecture model that are ready to be deployed while other portions undergo further development and testing, and/or intelligently routes percentages of traffic to designated services. A next stage of the new data architecture model may be deployed when it is determined that the previous stage has been successfully deployed and confirmed to be free of performance degradations.

In various embodiments, a bidirectional replication mechanism is used during development and testing of the new data architecture model to ensure that any data operations occurring in one model are accurately mirrored in the other model. As the new data architecture model is being developed and tested, an automated comparison system will monitor data flowing in and out of the data architecture model. For example, to test a function of the new data architecture model, the automated comparison framework may utilize a bidirectional replication mechanism to intercept an incoming API request being transmitted to the data architecture model, replicates the API request in an equivalent form suitable for the new data architecture model, and transmits the replicated equivalent API request to the new data architecture model.

The data architecture model receives the original API request and performs an appropriate action, which produces resultant data. This resultant data may be an API response, a log of data being read from, and/or written to a database, and/or the like.

The new data architecture model receives the equivalent API request and performs an appropriate action, which produces resultant data. This resultant data may be an API response, a log of data being read from, and/or written to a database, and/or the like.

The bidirectional replication mechanism ensures that actions taken in the data architecture model are accurately reflected in the new data architecture model, and vice versa. Whenever an entity is created, updated, or deleted, in one model, a corresponding event is seamlessly generated and transmitted by the bidirectional replication mechanism to the other model. Ensuring that the state of both models and their databases are in sync is a crucial step in the setup process of the automated comparison system. Any discrepancy between the two models will hinder the automated comparison system's ability to make accurate automated comparisons.

In various embodiments, synchronous response comparison is used to perform comparisons of data architecture model outputs resulting from synchronous actions. A synchronous action is defined as an action that is handled by the software system immediately upon receiving it. An example of a synchronous action is an API request. Synchronous response comparison occurs immediately upon generation of output by both models. Synchronous response comparison produces performance monitoring data used to evaluate the comparison.

In various embodiments, asynchronous response comparison is used to perform comparisons of data architecture model outputs resulting from asynchronous actions. An asynchronous action is defined as an action that is handled by an application framework upon satisfaction of conditional criteria, not immediately upon receiving it. An example of an asynchronous action is an event-based notification. Asynchronous response comparison occurs periodically and processes a large number of output pairs in bulk. Asynchronous response comparison produces performance monitoring data used to evaluate the comparison.

In various embodiments, performance monitoring data produced by synchronous and asynchronous response comparisons is used to determine if two outputs are equivalent. If two outputs are determined to not be equivalent, the performance monitoring data is analyzed to determine the cause of the inequivalence.

In various embodiments, synchronous response monitoring is used to analyze performance monitoring data produced by synchronous response comparisons and asynchronous response monitoring is used to analyze performance monitoring data produced by asynchronous response comparisons. This analysis identifies the aspects of the original outputs that are not equivalent, determines which data architecture model produced the incorrect output or caused the inequivalence. Results of this analysis are aggregated and studied by developers to assist in the debugging and maintenance process. For example, a pattern of inequivalence in a certain field of output data generated from a certain operation may be identified by synchronous or asynchronous response monitoring. Developers proceed to repair the data architecture model identified as the cause of the inequivalence to ensure that the data architecture model produces correct output moving forward.

Accordingly, data discrepancies and/or inaccuracies may be mitigated for a data architecture model by utilizing the automated comparison framework as disclosed herein. Additionally, by utilizing the automated comparison framework as disclosed herein, scalability, performance, and/or concurrency associated with a data architecture model may be provided. Therefore, quality and/or accuracy of data for a database system and/or data partition of an application framework system may be further improved. By utilizing the automated comparison framework as disclosed herein, computing resources and/or memory allocation with respect to processing and/or storage of data via a data architecture model may additionally or alternatively be improved. In doing so, various embodiments of the present disclosure make substantial technical contributions to improving the efficiency and/or the effectiveness of an application framework. Various embodiments of the present disclosure additionally or alternatively provide improved resiliency, management, and efficiency of data architecture models. Various embodiments of the present disclosure additionally or alternatively provide improved cross-product collaboration, improved scalability, improved service stability, improved usability, improved data quality, and/or improved interactions with respect to data related to an application framework. Additionally, by utilizing the automated comparison framework as disclosed herein, various embodiments of the present disclosure provide data quality assurance for application components of an application framework and/or for data provided to one or more client devices via an application framework system. In various embodiments, by utilizing the automated comparison framework as disclosed herein, provided to one or more client devices via an application framework system may be further optimized for transmission via a network, thereby improving efficiency of a network associated with an application framework system.

### Definitions

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer may read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

The terms “client device,” “computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a component made available by a server. The server is often, but not always, on another computer system, in which case the client accesses the component by way of a network. Embodiments of client devices may include, without limitation, smartphones, tablet computers, laptop computers, personal computers, desktop computers, enterprise computers, and/or the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “element” or “component” or “application component” refers to a computer functionality or a set of computer functionalities, such as the retrieval of specified information or the execution of a set of operations, with a purpose that different clients may reuse for their respective purposes, together with the policies that should control its usage, for example, based on the identity of the client (e.g., an application, another component, etc.) requesting the component. Additionally, a component may support, or be supported by, at least one other component via a component dependency relationship.

In some embodiments, a component is offered by one computing device over a network to one or more other computing devices. Additionally, the component may be stored, offered, and utilized by a single computing device to local applications stored thereon and in such embodiments a network would not be required. In some embodiments, components may be accessed by other components via a plurality of APIs, for example, JavaScript Object Notation (JSON), Extensible Markup Language (XML), Simple Object Access Protocol (SOAP), Hypertext Markup Language (HTML), the like, or combinations thereof. In some embodiments, components may be configured to capture or utilize database information and asynchronous communications via message queues (e.g., Event Bus). Non-limiting examples of components include an open source API definition format, an internal developer tool, web based HTTP components, databased components, and asynchronous message queues which facilitate component-to-component communications.

In some embodiments, a component may represent an operation with a specified outcome and may further be a self-contained computer program. In some embodiments, a component from the perspective of the client (e.g., another component, application, etc.) may be a black box (e.g., meaning that the client need not be aware of the component's inner workings). In some embodiments, a component may be associated with a type of feature, an executable code, two or more interconnected components, and/or another type of component associated with an application framework.

In some embodiments, a component may correspond to a service (e.g., a web service). Additionally or alternatively, in some embodiments, a component may correspond to a library (e.g., a library of components, a library of services, etc.). Additionally or alternatively, in some embodiments, a component may correspond to one or more modules. Additionally or alternatively, in some embodiments, a component may correspond to one or more machine learning models. For example, in some embodiments, a component may correspond to a service associated with a type of service, a service associated with a type of library, a service associated with a type of feature, a service associated with an executable code, two or more interconnected services, and/or another type of service associated with an application framework. The term “component object identifier” refers to one or more data items or elements by which a component object may be uniquely identified. The component object identifier may include, for example, one or more of Internet Protocol (IP) addresses associated with a component, Uniform Resource Locators (URLs) associated with a component, numerical characters, alphabetical characters, alphanumeric codes, American Standard Code for Information Interchange (ASCII) characters, encryption keys, identification certificates, the like, or combinations thereof. An example embodiment of a component object identifier may comprise data provided by at least a component author, for example, a URL and a payload associated with a component. In some embodiments, the payload comprises a JSON formatted text that is either posted, by way of an HTTP POST, to a component when a resource is created or returned from a component, through an HTTP GET, when at least a resource is requested from the component.

The term “application framework” refers to a computing environment associated with one or more computing devices and one or more components (e.g., one or more application components), where the environment enables interactions with respect to components supporting at least one application. For example, an application framework may be a system (e.g., a server system, a cloud-based system, an enterprise system, etc.) where multiple components, multiple resources associated with components, multiple layers of components, and/or multiple layers of resources interact with one another in several complex manners. In some embodiments, the components are associated directly or indirectly with an application supported by the components. In some embodiments, the components may support the application over one or more communication networks. The application framework may include one or more components to generate and update a repository of collected information for each component (e.g., an event object repository). Accordingly, the application framework may provide for the collection of information, in the form of event objects, to facilitate monitoring of event streams associated with one or more components of the application framework. In certain embodiments, the application framework may be configured as a collaborative application framework that manages one or more collaborative applications such as, for example, one or more collaborative document applications, collaborative software development applications, and/or one or more other types of collaborative applications. In certain embodiments, the application framework may be configured as an enterprise instance of a collaboration and knowledge base component platform for managing documents and/or encouraging collaboration among users. In certain embodiments, the application framework may be configured as a service management software platform. In certain embodiments, the application framework may alternatively be configured to manage one or more project management applications, one or more work management applications, one or more software development applications, one or more product development applications, one or more portfolio management applications, or one or more other types of applications. In certain embodiments, the application framework may be configured as an enterprise instance of an information technology service management software platform. However, it is to be appreciated that, in other embodiments, the application framework may be configured as another type of component platform.

The term “application framework system” refers to a system that includes both a server framework and a repository framework to support the server framework. For example, an application framework refers to a system that includes a computing environment associated with one or more computing devices and one or more components, as well as a repository of collected information for each component and/or each computing device.

The term “application,” “app,” or similar terms refer to a computer program or group of computer programs designed for use by and interaction with one or more networked or remote computing devices. In some embodiments, an application refers to a mobile application, a desktop application, a command line interface (CLI) tool, or another type of application. Examples of an application comprise workflow engines, component desk incident management, team collaboration suites, cloud components, word processors, spreadsheets, accounting applications, web browsers, email clients, media players, file viewers, videogames, and photo/video editors. An application may be supported by one or more components either via direct communication with the component or indirectly by relying on a component that is in turn supported by one or more other components.

The term “service” refers to a type of component. In some embodiments, a service provides a visual representation of one or more data structures. In some embodiments, a service is configured for viewing data, searching for data, creating data, updating data, managing relationships among data, assigning attributes related to data, and/or storing data associated with one or more data structures. In some embodiments, a service is configured as a system, tool or product to facilitate viewing data, searching for data, creating data, updating data, managing relationships among data, assigning attributes related to data, and/or storing data associated with one or more data structures. In some embodiments, a service comprises a set of metadata attributes associated with a technical capability, a technical configuration, an application capability, an application configuration, and/or another metadata attribute. In some embodiments, a service is published to one or more client devices via one or more APIs. In some embodiments, a service is a logical representation of an application stack. In some embodiments, a service corresponds to one or more microservices.

The term “microservices” refers to a set of services that are interconnected and independently configured to provide a monolith service. In some embodiments, a microservice is configured with one or more APIs integrated with one or more other microservices and/or one or more other applications. In some embodiments, a microservice is a single-function module with a defined set of interfaces and/or a defined set of operations configured to integrate with one or more other microservices and/or one or more other applications to provide a monolith service.

The terms “internal component,” “internal resource,” or similar terms refer to a program, application, platform, or component that is configured by a developer to provide functionality to another one or more of their programs, applications, platforms, or components, either directly or indirectly through one or more other components, as opposed to using an external component. Internal components operate on a compiled code base or repository that is at least partially shared by an application which utilizes the functionality provided by the internal component. In some embodiments, the application code base and the internal component code base are hosted on the same computing device or across an intranet of computing devices. An application communicates with internal components within a shared architectural programming layer without external network or firewall separation. In some embodiments, an internal component is used only within the application layer which utilizes the internal components functionality. Information related to internal components may be collected and compiled into component objects which may also be referred to as internal component objects. An example embodiment of an internal component is a load balancer configured for routing and mapping API and/or component locations. Internal components may be configured for information-based shard routing, or in other words, routing and mapping API and/or component locations based on predefined custom component requirements associated with an application. For example, an internal component may be configured to identify where communication traffic originates from and then reply to the communications utilizing another component for reply communication.

The terms “external component,” “external resource,” “remote resource,” or similar terms refer to a program, application, platform, or component that is configured to communicate with another program, application, platform, or component via a network architecture. In some embodiments, communications between an external component and an application calling the external component takes place through a firewall and/or other network security features. The external component operates on a compiled code base or repository that is separate and distinct from that which supports the application calling the external component. The external components of some embodiments generate data or otherwise provide usable functionality to an application calling the external component. In other embodiments, the application calling the external component passes data to the external component. In some embodiments, the external component may communicate with an application calling the external component, and vice versa, through one or more APIs. For example, the application calling the external component may subscribe to an API of the external component that is configured to transmit data. In some embodiments, the external component receives tokens or other authentication credentials that are used to facilitate secure communication between the external component and an application calling the external component in view of the applications network security features or protocols (e.g., network firewall protocols). An example embodiment of an external component may include cloud components (e.g., AWS®).

The term “repository” refers to a database, a datastore, and/or a memory device which is accessible by one or more computing devices for retrieval and storage of one or more data components, the like, or combinations thereof. The repository may be configured to organize data components stored therein in accordance with one or more particular data classification labels or other attributes attributed to the data component (e.g., a scoring metric, file size, file type, etc.). For example, a repository may be structured in accordance with one or more data components associated with one or more services, applications, data classification labels, internal resources, external resources, network functions, APIs, the like, or combinations thereof. In some embodiments, a repository may be at least partially stored on one or more of a server, remotely accessible by a computing device, or on a memory device on-board the computing device.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

The term “automated comparison system” is used to refer to an application framework which interacts with a plurality of data architecture models to perform comparative analysis of structured data objects generated by the plurality of data architecture models.

The term “data architecture model” is used to refer to a model and/or software system constructed according to a specific data architecture design pattern. In some embodiments, a data architecture model is constructed in accordance with a monolith architecture and/or the like. In some embodiments, a data architecture model is equipped to transmit and receive data and perform computations or subroutines in accordance with a set of instructions provided by software code. In some embodiments, an application framework may utilize a data architecture model to enable functionality of one or more application components. In some embodiments, it may be desirable to update a data architecture model of the application framework to improve performance and/or functionality of the application components. For example, a data architecture model may be an old data architecture model for the application framework.

The term “enhanced data architecture model” is used to refer to an enhanced model and/or software system constructed according to a specific data architecture design pattern that is different than a data architecture design pattern of a data architecture model. For example, an enhanced data architecture model may be a new data architecture model as compared to the data architecture model (e.g., an old data architecture model). In some embodiments, an enhanced data architecture model is constructed in accordance with a microservice architecture, a microkernel architecture, a client-server architecture, a model-view-controller architecture, a service-oriented architecture, and/or the like. In some embodiments, an enhanced data architecture model is equipped to transmit and receive data and perform computations or subroutines in accordance with a different set of instructions provided by software code as compared to the set of instructions associated with the data architecture model (e.g., an old data architecture model). In some embodiments, an application framework may utilize the enhanced data architecture model to enable improved functionality and/or performance of one or more application components. In some embodiments, a data architecture comparison apparatus may route instruction data objects (e.g., customer requests, API requests, etc.) to the data architecture model and the enhanced data architecture model simultaneously. Additionally, responses from the data architecture model and the enhanced data architecture model may be created. In various embodiments, responses from the data architecture model may be transmitted to one or more client devices associated with the instruction data objects (e.g., to one or more users) while responses from the enhanced data architecture model are assessed for performance criteria.

The term “structured data object” is used to refer to computer-readable and computer-transmittable data generated by a data architecture model. In some embodiments, a structured data object may be generated in response to an action performed by a data architecture model. In some embodiments, a structured data object contains metadata, property data, attribute data, and/or output of an execution of a software process. In some embodiments, a structured data object is organized as JSON, raw text, markup text, web API Responses, internal API responses, event-based notification responses, and/or the like. In some embodiments, a structed data object is generated based on an instruction data object.

In some embodiments, an instruction data object may be a data structure that represents at least a portion of a service message related to a service request for the application framework system. The instruction data object can take the structural form of a vector or other appropriate data structure for representing a service message. Additionally, an instruction data object can be received by one or more computing devices (e.g., servers, systems, platforms, etc.) which are configured to cause an application framework system to perform one or more actions associated with one or more service event workflows and/or one or more components of the application framework system. In some embodiments, an instruction data object may be associated with an information technology (IT) support ticket. In some embodiments, an instruction data object may be associated with an incident, problem, change, and/or the like associated with an application framework. In some embodiments, an instruction data object may be associated with an incident, problem, change, and/or the like associated with a client device. In some embodiments, an instruction data object may be associated with an incident, problem, change, and/or the like associated with a component, service, and/or microservice of an application framework.

In some embodiments, an instruction data object may be received by an application framework system via a communication channel or the like. In one or more embodiments, the instruction data object may be generated by a client device via one or more computer program instructions. In various embodiments, an instruction data object can be generated via a service ticket, a service message, a service request, a service conversation, an API call, an application portal, a chat message conversation, an email exchange, a web interface, a widget interface, a workflow, a collaborative dashboard, a service management application, a project management application, a work management application, a software development application, a product development application, a portfolio management application, a collaborative application, or another type of process related to an application framework.

The term “instruction data object” is used to refer to computer-readable and computer-transmittable data indicative of instructions to perform a software computation or subroutine. In some embodiments, an instruction data object is received and interpreted by a data architecture model, which causes the data architecture model to perform a software computation or subroutine in accordance with the instructions contained within an instruction data object. In some embodiments, an instruction data object takes the form of a web API request, an internal API request, or an event-based notification.

The term “comparison” is used to refer to an action performed by an automated comparison system which compares two or more structured data objects to determine if the two or more structured data objects are substantially equivalent. In some embodiments, a structured data object generated by a monolith data architecture model (e.g., a “monolith model”) is compared to a structured data object generated by an enhanced data architecture model (e.g., a “microservice model”). In some embodiments, the two structured data objects are deemed substantially equivalent if it is determined that each contains equivalent relevant data. Such a determination results in a comparison success, while an opposite determination results in a comparison failure.

The term “comparison success” is used to refer to the result of a comparison which determined that two or more structured data objects are substantially equivalent.

The term “comparison failure” is used to refer to the result of a comparison which determined that two or more structured data objects are not substantially equivalent.

The term “performance monitoring data” is used to refer to data generated by an automated comparison system in response to a comparison success or comparison failure between structured data objects. In some embodiments, performance monitoring data comprises indications of causes of the comparison failure. Such causes include, without limitation, differing metadata, properties, attributes, content, and/or origins of data associated with the structured data objects. For example, the performance monitoring data may include a particular type of metadata discrepancy between a first structured data object provided by a data architecture model and a second structured data object provided by an enhanced data architecture model. The performance monitoring data may additionally or alternatively include a particular type of data property and/or data formatting discrepancy between a first structured data object provided by a data architecture model and a second structured data object provided by an enhanced data architecture model. The performance monitoring data may additionally or alternatively include a particular type of attribute discrepancy between a first structured data object provided by a data architecture model and a second structured data object provided by an enhanced data architecture model. The performance monitoring data may additionally or alternatively include a particular type of data content discrepancy between a first structured data object provided by a data architecture model and a second structured data object provided by an enhanced data architecture model. The performance monitoring data may additionally or alternatively include a particular type of data origin discrepancy between a first structured data object provided by a data architecture model and a second structured data object provided by an enhanced data architecture model. The performance monitoring data may additionally or alternatively include a particular type of discrepancy between first partition data associated with a first structured data object provided by a data architecture model and second partition data associated with a second structured data object provided by an enhanced data architecture model.

The term “event-based notification” is used to refer to a response to any event within a data architecture model that triggers a corresponding action to be performed by a data architecture model. In some embodiments, when an event is detected, an event-based notification is transmitted to an appropriate component of a data architecture model designed to handle the processing of a given event based on the content of the event-based notification. In some embodiments, an event-based notification is an example of an instruction data object.

The term “event-based notification response” is used to refer to output of a data architecture model after receipt of an event-based notification and performing an appropriate action or computation based on the content of the event-based notification. In some embodiments, an event-based notification response is an example of a structured data object.

The term “machine learning model” refers to a data entity that describes parameters, hyper-parameters, and/or defined operations configured, trained, and/or the like to generate an output for a predictive task, a classification task, and/or a generative task using machine learning techniques. For example, a machine learning model can include one or more layers, one or more rule-based layers, one or more neural network layers, and/or one or more other types of layers that depend on trained parameters, coefficients, and/or the like. In some embodiments, machine learning model can include any type of model configured, trained, and/or the like to generate an output for a predictive task, a classification task, and/or a generative task in any predictive domain. A machine learning model can include one or more of any type of machine learning model including one or more supervised, unsupervised, semi-supervised, reinforcement learning models, and/or the like. For instance, a machine learning model may include a supervised model that can be trained using a historical training dataset. In some examples, a machine learning model can include multiple models configured to perform one or more different stages of a classification and/or prediction process. In various embodiments, a machine learning model can be configured as a neural network model, a deep learning model, a convolutional neural network (CNN) model, a natural language processing (NLP) model, a large language model (LLM), a generative model, a transformer model, and/or another type of machine learning model. In some embodiments, a machine learning model may be configured to generate one or more instruction data objects. In some embodiments, a data architecture model may include one or more machine learning models.

The term “large language model” refers to a generative machine learning model configured to generate an output for a particular generative task. In some embodiments, the large language model may be configured as or otherwise be associated with an autoregressive LLM, a generative pre-trained transformer (GPT) model, or another type of generative machine learning model configured to generate output for a particular generative task. In some embodiments, a large language model may be configured to generate one or more instruction data objects. In some embodiments, a data architecture model may include one or more large language models.

The term “interaction signal” refers to a signal received by one or more computing devices (e.g., servers, systems, platforms, etc.) which are configured to cause an application framework system to perform one or more actions associated with one or more components of the application framework system. The interaction signal may be received via a component management interface, an API, a communication interface, the like, or combinations thereof. In one or more embodiments, the interaction signal may be generated by a client device via one or more computer program instructions. In various embodiments, an interaction signal may be generated via a collaborative application, event, event stream, or the like. Additionally or alternatively, the interaction signal may cause one or more actions, one or more changes, and/or one or more predictive inferences with respect to a collaborative application, event, event stream, or the like.

The term “interface element” refers to a rendering of a visualization and/or human interpretation of data associated with an application framework and/or a distributed ledger system. In one or more embodiments, an interface element may additionally or alternatively be formatted for transmission via one or more networks. In one or more embodiments, an interface element may include one or more graphical elements and/or one or more textual elements.

The term “visualization” refers to visual representation of data to facilitate human interpretation of the data. In some embodiments, visualization of data includes graphic representation and/or textual representation of data.

The term “graphical control element” refers to a computer input element that allows a user to enter input to facilitate one or more actions with respect to an application framework.

The term “interface area” refers to an area of an electronic interface, where the area may be situated in relation to one or more other interface areas of the electronic interface. An interface area may be comprised of groupings of pixels, or may be defined according to coordinates of a display device configured to render the interface. A size of an interface may be adjusted according to parameters associated with the display device. An interface area may include one or more interface elements. For example, an interface element may include a visualization. In certain embodiments, an interface area may include one or more graphical elements and/or or more textual elements. In certain embodiments, an interface area may be void of an interface element and/or a visualization. In certain embodiments, an interface area may include a graphical control element and/or one or more other interactive interface elements.

Thus, use of any such terms, as defined herein, should not be taken to limit the spirit and scope of embodiments of the present disclosure.

### Exemplary System Architecture

Methods, apparatuses, and computer program products of the present disclosure may be embodied by any of a variety of devices. For example, the method, apparatus, and computer program product of an example embodiment may be embodied by a networked device (e.g., an enterprise platform, etc.), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a PDA, mobile telephone, smartphone, laptop computer, tablet computer, wearable, the like or any combination of the aforementioned devices.

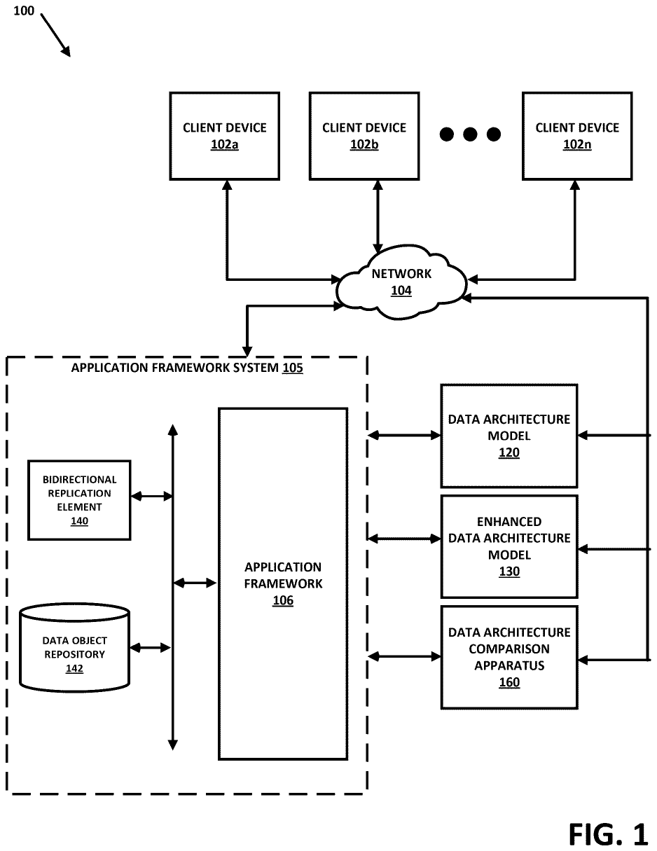

FIG. 1 illustrates an example system architecture 100 within which embodiments of the present disclosure may operate. The system architecture 100 includes an application framework system 105 configured to interact with one or more client devices 102a-n, such as client device 102a, client device 102b, and/or client device 102n. In one or more embodiments, the one or more client devices 102a-n may be configured to interact with one or more components managed by an application framework 106 of the application framework system 105. For example, in one or more embodiments, the one or more client devices 102a-n may be configured to send data to the one or more components managed by the application framework 106 and/or receive data from the one or more components managed by the application framework 106. In one or more embodiments, the one or more components may interact with one another in several complex manners to provide collaborative applications and/or collaborative services.

In one or more embodiments, the application framework system 110 includes the application framework 106, a bidirectional replication element 140, and/or a data object repository 142. The data object repository 142 may store one or more data objects and/or data for one or more component objects associated therewith. In some embodiments, the one or more data objects stored in the data object repository 142 may include and/or may be stored with data sent to and/or received from the one or more components. The data object repository 142 may include one or more storage units, such as multiple distributed storage units that are connected through a computer network. Each storage unit in the data object repository 142 may store one or more data objects. Moreover, each storage unit in the data object repository 142 may include one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

The system architecture 100 also includes a data architecture comparison apparatus 160. In an embodiment, the data architecture comparison apparatus 160 is implemented separate from the application framework system 110. Alternatively, in certain embodiments, the application framework system 110 may include the data architecture comparison apparatus 160. In various embodiments, the application framework system 110 and/or the data architecture comparison apparatus 160 may also be configured to interact with the one or more client devices 102a-n. In various embodiments, the data architecture comparison apparatus 160 may be configured to interact with application framework system 110. For example, in one or more embodiments, the data architecture comparison apparatus 160 may be configured to interact with and/or manage one or more components of the application framework system 110 and/or one or more databases of the data object repository 142. In some embodiments, the data architecture comparison apparatus 160 is configured to manage and/or analyze one or more data objects stored in the data object repository 142. In some embodiments, the data architecture comparison apparatus 160 is configured to manage access to the data object repository 142. For example, in some embodiments, the data architecture comparison apparatus 160 is configured to manage authorization of one or more data access requests and/or or more data write requests with respect to the data object repository 142.

In some embodiments, the system architecture 100 additionally includes a data architecture model 120 and an enhanced data architecture model 130. In an embodiment, the data architecture model 120 and/or the enhanced data architecture model 130 is implemented separate from the application framework system 110. Alternatively, in certain embodiments, the application framework system 110 may include the data architecture model 120 and/or the enhanced data architecture model 130. In some embodiments, data architecture model 120 is a model and/or software system constructed according to a specific data architecture design pattern. In some embodiments, the data architecture model 120 is constructed in accordance with a monolith architecture and/or the like. In some embodiments, the data architecture model 120 is equipped to transmit and receive data and perform computations or subroutines in accordance with a set of instructions provided by software code. In some embodiments, the application framework 106 may utilize the data architecture model 120 to enable functionality of one or more application components of the application framework 106. In some embodiments, it may be desirable to update the data architecture model 120 to improve performance and/or functionality of the application framework 106 and/or one or more application components of the application framework 106. For example, the data architecture model 120 may be an old data architecture model for the application framework 106 and the enhanced data architecture model 130 may be a new data architecture model for the application framework 106.

The enhanced data architecture model 130 may be enhanced model and/or software system constructed according to a specific data architecture design pattern that is different than a data architecture design pattern of the data architecture model 20. For example, the enhanced data architecture model 130 may be a new data architecture model as compared to the data architecture model 120. In some embodiments, the enhanced data architecture model 130 is constructed in accordance with a microservice architecture, a microkernel architecture, a client-server architecture, a model-view-controller architecture, a service-oriented architecture, and/or the like. In some embodiments, the enhanced data architecture model 130 is equipped to transmit and receive data and perform computations or subroutines in accordance with a different set of instructions provided by software code as compared to the set of instructions associated with the enhanced data architecture model 130. In some embodiments, the application framework 106 may utilize the enhanced data architecture model 130 to enable improved functionality and/or performance of the application framework 106 and/or one or more application components of the application framework 106.

In some embodiments, the data architecture comparison apparatus 160 may route instruction data objects (e.g., customer requests, API requests, etc.) to the data architecture model 120 and the enhanced data architecture model 130 simultaneously. Additionally, responses from the data architecture model 120 and the enhanced data architecture model 130 may be respectively generated by the data architecture model 120 and the enhanced data architecture model 130. In various embodiments, responses from the data architecture model 120 may be transmitted to one or more client devices 102a-b while responses from the enhanced data architecture model 130 are assessed for performance criteria. In some embodiments, the enhanced data architecture model 130 may be transitioned to a current data architecture model for the application framework 106 and/or the data architecture model 120 may be de-transitioned from operation with respect to the application framework 106 in response to a determination that the performance criteria is satisfied.

The application framework system 110, the data architecture comparison apparatus 160, the data architecture model 120, the enhanced data architecture model 130, and/or the one or more client devices 102a-n may be in communication using a network 104. Additionally or alternatively, in various embodiments, the application framework system 110, the data architecture comparison apparatus 160, the data architecture model 120 and/or the enhanced data architecture model 130 may be in communication via a backend network and/or an enterprise network separate from the one or more client devices 102a-n. The network 104 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 104 (e.g., network routers, etc.). For example, the network 104 may include a cellular telephone, an 802.11, 802.16, 802.20, and/or WiMAX network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JSON objects sent via a WebSocket channel. In some embodiments, the protocol is JSON over RPC, JSON over REST/HTTP, the like, or combinations thereof.

A client device from the one or more client devices 102a-n may include a mobile device, a smart phone, a tablet computer, a laptop computer, a wearable device, a personal computer, an enterprise computer, a virtual reality device, or another type of computing device. In one or more embodiments, a client device from the one or more client devices 102a-n includes geolocation circuitry configured to report a current geolocation of the client device. In some embodiments, the geolocation circuitry of the client device may be configured to communicate with a satellite-based radio-navigation system such as the global position satellite (GPS), similar global navigation satellite systems (GNSS), or combinations thereof, via one or more transmitters, receivers, the like, or combinations thereof. In some embodiments, the geolocation circuitry of the client device may be configured to infer an indoor geolocation and/or a sub-structure geolocation of the client device using signal acquisition and tracking and navigation data decoding, where the signal acquisition and tracking and the navigation data decoding is performed using GPS signals and/or GPS-like signals (e.g., cellular signals, etc.). Other examples of geolocation determination include Wi-Fi triangulation and ultra-wideband radio technology.

In one or more embodiments, the application framework system 105 may be configured to receive one or more interaction signals from one or more of the client devices 102a-n. An interaction signal refers to a signal configured to cause one or more actions with respect to the application framework 106. For example, an interaction signal may be a signal configured to cause one or more actions with respect to one or more computing devices and or one or more components managed by the application framework 106. An interaction signal may be generated by the one or more client devices 102a-n and may be received via a component management interface of the application framework 106, an API of the application framework 106, a communication interface of the application framework 106, the like, or combinations thereof. Based on the one or more interaction signals, the application framework system 105 may perform one or more actions with respect to the application framework 106. In various embodiments, the one or more actions may be associated with one or more user identifiers associated with one or more events with respect to one or more components of the application framework 106. For example, the one or more actions may initiate and/or correspond to one or more events with respect to one or more components of the application framework 106. In certain embodiments, the one or more actions may be associated with one or more events with respect to a one or more computing devices and or one or more components managed by the application framework 106. In certain embodiments, the one or more actions may be associated with one or more user identifiers with respect to one or more computing devices and or one or more components managed by the application framework 106. In some embodiments, the data architecture comparison apparatus 160 may manage and/or configure one or more components of the application framework system 110 and/or one or more portions of the data object repository 142.

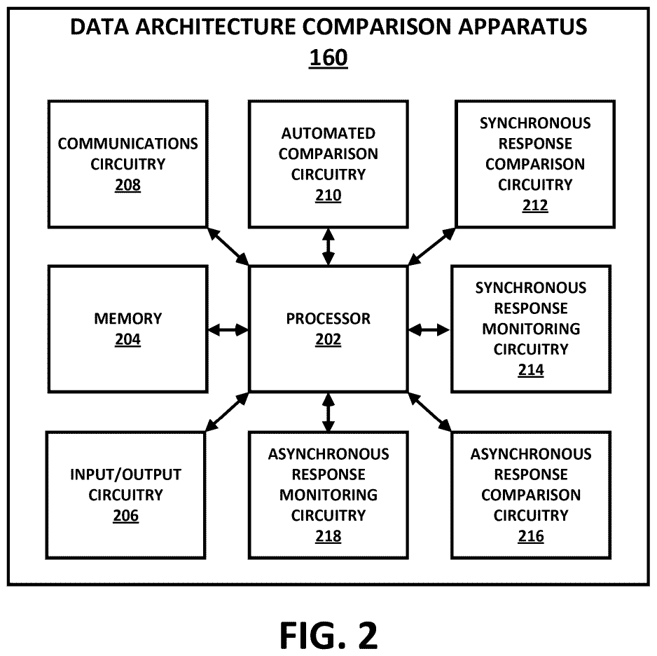

The data architecture comparison apparatus 160 may be embodied by one or more computing systems, such the data architecture comparison apparatus 160 illustrated in FIG. 2. In one or more embodiments, the data architecture comparison apparatus 160 may include processor 202, memory 204, input/output circuitry 206, communications circuitry 208, automated comparison circuitry 210, synchronous response comparison circuitry 212, synchronous response monitoring circuitry 214, asynchronous response comparison circuitry 216, and/or asynchronous response monitoring circuitry 218. The data architecture comparison apparatus 160 may be configured to execute the operations described herein. Although these components 202-218 are described with respect to functional limitations, it should be understood that the particular implementations necessarily include the use of particular hardware. It should also be understood that certain of these components 202-218 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the techniques and/or operations described herein when the instructions are executed.

In some embodiments, the data architecture comparison apparatus 160 may include input/output circuitry 206 that may, in turn, be in communication with processor 202 to provide output to the user and, in some embodiments, to receive an indication of a user input. In some embodiments, the input/output circuitry 206 may be configured to render a user interface. Additionally or alternatively, the input/output circuitry 206 may be configured to render and/or control a display, and may comprise a web user interface, a mobile application, a query-initiating computing device, a kiosk, or the like. In some embodiments, the input/output circuitry 206 may be communicatively coupled to and/or include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the data architecture comparison apparatus 160. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae.

In some embodiments, the communications circuitry 208 may act as an intermediary for one or more components of the application framework system 110. For example, the communications circuitry 208 may receive and process requests, call, messages, and/or the like for one or more components of the application framework system 110. In some embodiments, the communications circuitry 208 may additionally or alternatively support data routing, traffic control, security, decryption, encryption, optimization, and/or the like for data associated with one or more components of application framework system 110. For example, the communications circuitry 208 may receive a data object and perform one or more subsequent actions based on the data object. In some embodiments, the communications circuitry 208 may provide functionality of a service proxy for one or more components of the application framework system 110. In some embodiments, the communications circuitry 208 may also be configured to generate access logs and/or historical data including information associated with a particular computing device, component, component object, the like, or combinations thereof.

In some embodiments, the communications circuitry 208 may be any means such as a device or circuitry embodied in either hardware or a combination of hardware and software that is configured to interact with the application framework system 110 and/or the one or more client devices 102a-n. In various embodiments, the communications circuitry 208 may monitor, analyze, and/or process data associated with the application framework system 110 such as, for example, data stored in the data object repository 142 and/or data related to a collaborative application. For example, in various embodiments, the communications circuitry 208 may monitor event streams associated with the application framework system 110 to detect respective candidate actions related to components of the application framework system 110. In certain embodiments, the communications circuitry 208 may be configured to retrieve metadata associated with the application framework system 110 and/or the data object repository 142 to facilitate detection of respective candidate actions related to components of the application framework system 110. The metadata may include, for example, data associated with relationships, sources, targets, ownership, consumption, libraries, activities, attributes, incidents, communication channels, dashboards, data repositories, labels, descriptions, and/or other data related to the application framework system 110 and/or the data object repository 142. In some embodiments, to facilitate monitoring of event streams, the communications circuitry 208 may be configured to ping one or more computing devices of the application framework system 110, such as via an internet control message protocol, to receive information related to one or more components of the application framework system 110. In some embodiments, to obtain data objects, the communications circuitry 208 may transmit one or more API calls to one or more API servers associated with the noted client devices.

The automated comparison circuitry 210 may be any means such as a device or circuitry embodied in either hardware or a combination of hardware and software that is configured to interact with the application framework system 110 and/or the one or more components of the application framework system 110. For example, the automated comparison circuitry 210 may be any means such as a device or circuitry embodied in either hardware or a combination of hardware and software that is configured to interact with the application framework 106, the bidirectional replication element 140, and/or the data object repository 142.

The synchronous response comparison circuitry 212 may be any means such as a device or circuitry embodied in either hardware or a combination of hardware and software that is configured to interact with the application framework system 110 and/or the one or more components of the application framework system 110. For example, the synchronous response comparison circuitry 212 may be any means such as a device or circuitry embodied in either hardware or a combination of hardware and software that is configured to interact with the application framework 106, the bidirectional replication element 140, and/or the data object repository 142.

The synchronous response monitoring circuitry 214 may be any means such as a device or circuitry embodied in either hardware or a combination of hardware and software that is configured to interact with the application framework system 110 and/or the one or more components of the application framework system 110. For example, the synchronous response monitoring circuitry 214 may be any means such as a device or circuitry embodied in either hardware or a combination of hardware and software that is configured to interact with the application framework 106, the bidirectional replication element 140, and/or data object repository 142.

The asynchronous response comparison circuitry 216 may be any means such as a device or circuitry embodied in either hardware or a combination of hardware and software that is configured to interact with the application framework system 110 and/or the one or more components of the application framework system 110. For example, the asynchronous response comparison circuitry 216 may be any means such as a device or circuitry embodied in either hardware or a combination of hardware and software that is configured to interact with the application framework 106, the bidirectional replication element 140, and/or the data object repository 142.

The asynchronous response monitoring circuitry 218 may be any means such as a device or circuitry embodied in either hardware or a combination of hardware and software that is configured to interact with the application framework system 110 and/or the one or more components of the application framework system 110. For example, the asynchronous response monitoring circuitry 218 may be any means such as a device or circuitry embodied in either hardware or a combination of hardware and software that is configured to interact with the application framework 106, the bidirectional replication element 140, and/or the data object repository 142.

In some embodiments, one or more external systems (such as a remote cloud computing and/or data storage system) may also be leveraged to provide at least some of the functionality discussed herein.

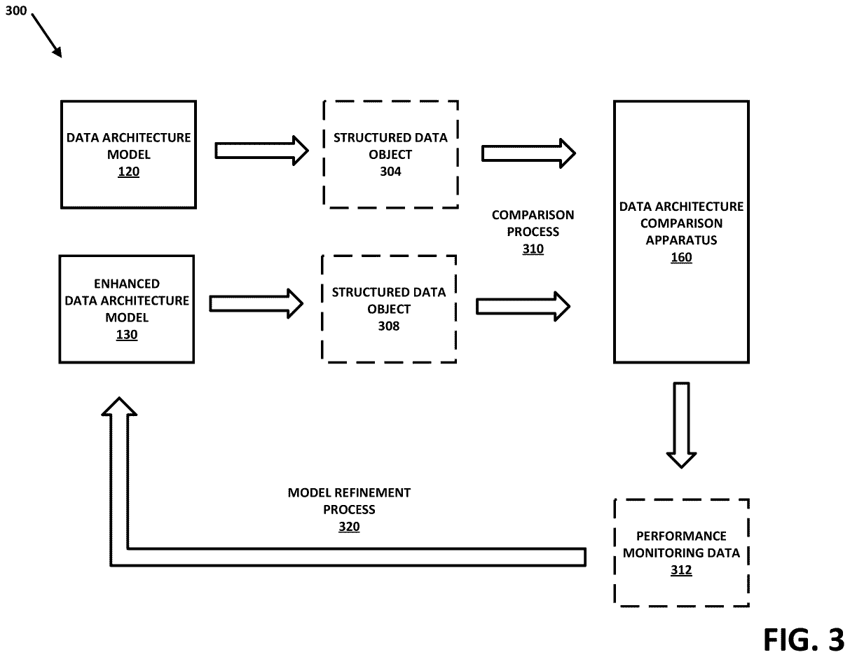

Referring to FIG. 3, an example data flow 300 is presented in accordance with one or more embodiments of the present disclosure. The data flow depicts functionality between various sub-systems of the present disclosure, including data architecture model 120, enhanced data architecture model 130, and data architecture comparison apparatus 160. One or more portions of the data flow may be executed and/or performed by the data architecture comparison apparatus 160.

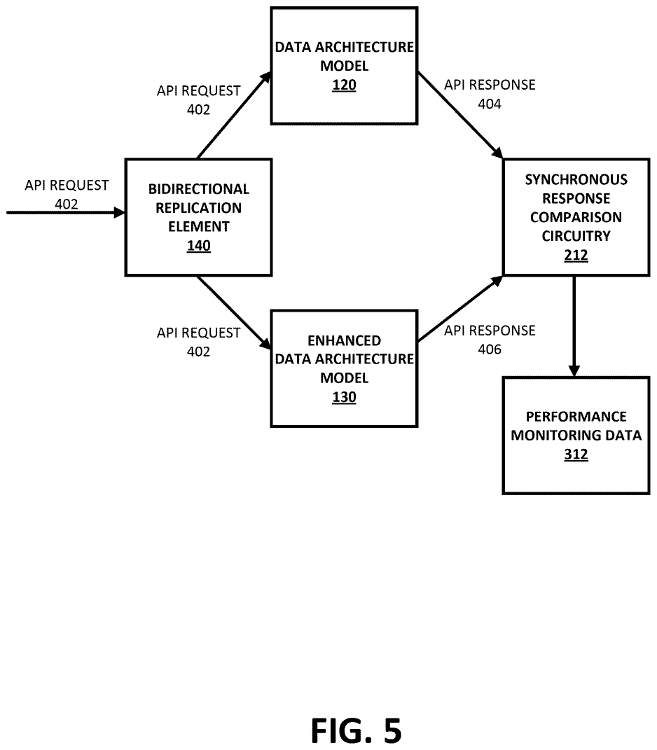

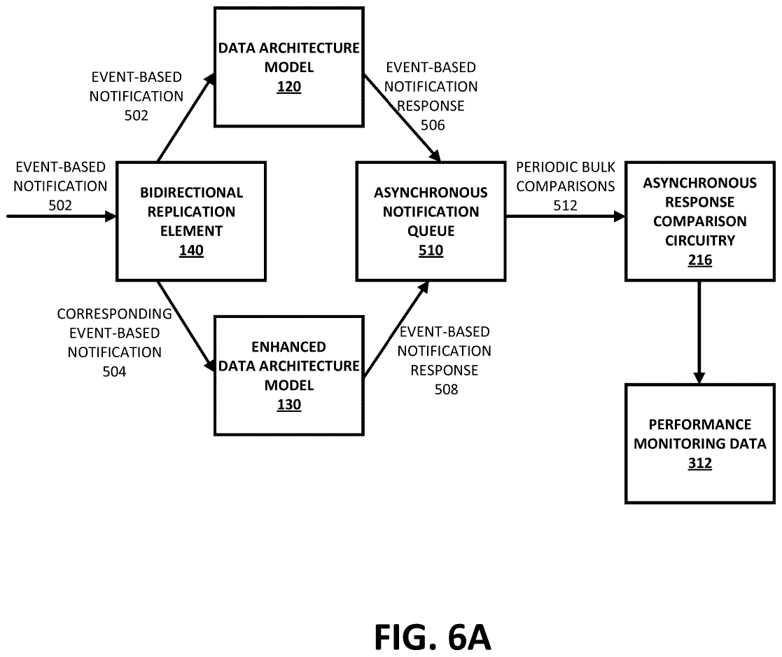

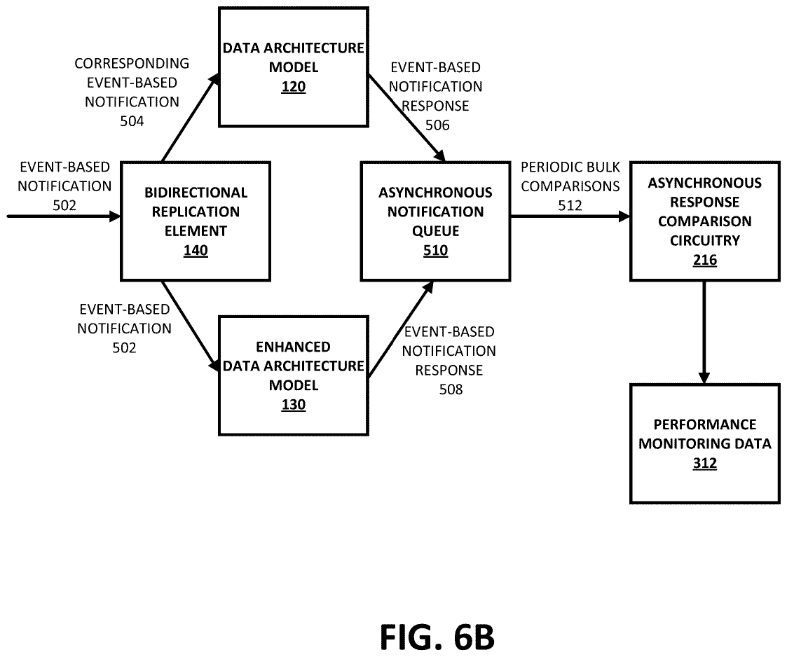

In various embodiments, data architecture model 120 generates a structured data object 304 and microservice model generates a structured data object 308. Structured data object 304 and structured data object 308 may be compared by the data architecture comparison apparatus 160 via comparison process 310. In various embodiments, comparison process 310 may be performed by synchronous response comparison circuitry 212 and/or asynchronous response comparison circuitry 216 in accordance with the methods described further herein with respect to FIG. 5, FIG. 6A, and FIG. 6B. In various embodiments, as a result of comparison process 310, data architecture comparison apparatus 160 may generate performance monitoring data 312.

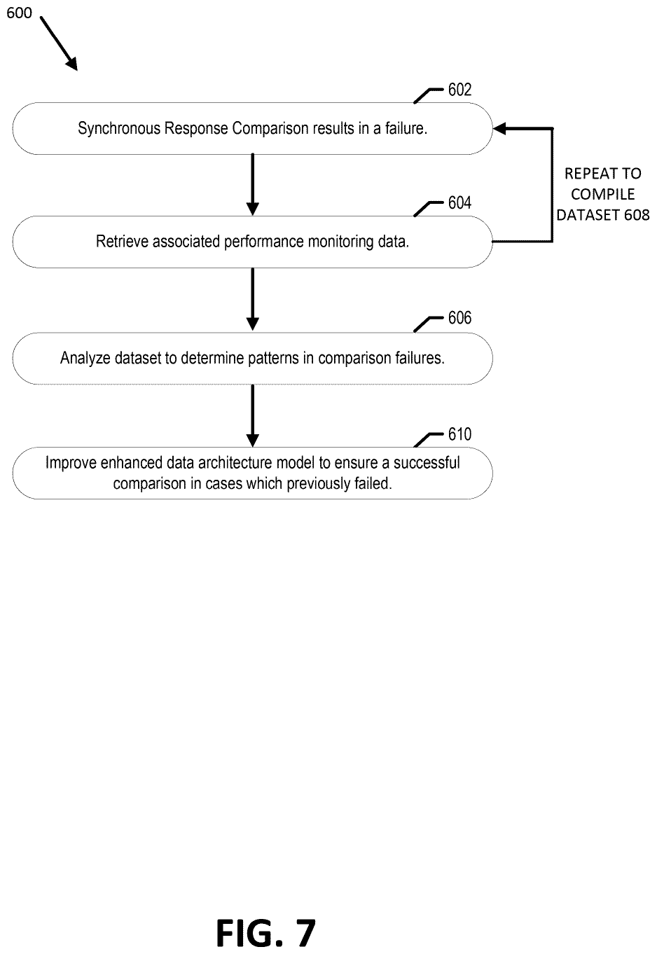

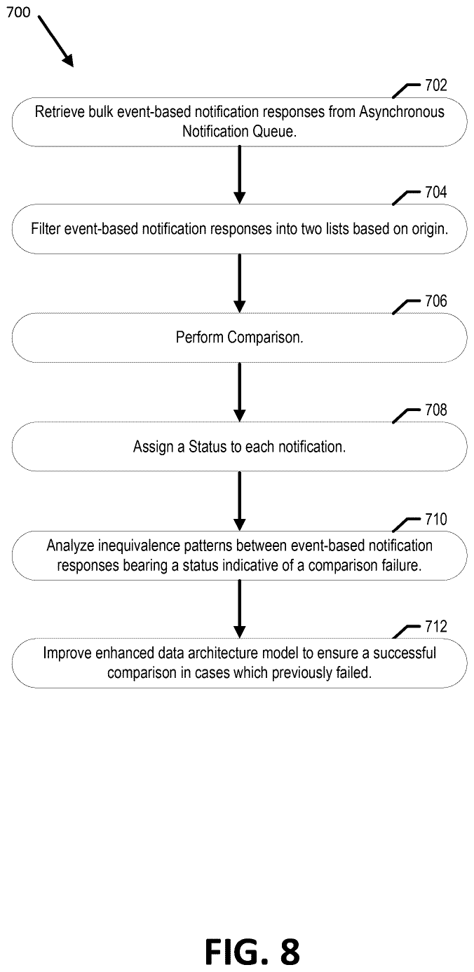

In various embodiments, the performance monitoring data 312 is utilized by model refinement process 920 to further refine and improve enhanced data architecture model 130. Model refinement process 920 may be performed by synchronous response monitoring circuitry 214 and/or asynchronous response monitoring circuitry 218 in accordance with the processes further described herein with respect to FIG. 7 and FIG. 8.

In some embodiments, the data architecture comparison apparatus 160 may receive the structured data object 304 generated by the data architecture model 120. In some embodiments, the data architecture model 120 may receive an instruction data object and may generate the structured data object 304 based on the instruction data object. Additionally, the data architecture comparison apparatus 160 may receive the structured data object 308 generated by the enhanced data architecture model 130. In some embodiments, the enhanced data architecture model 130 may receive the instruction data object and may generate the structured data object 308 based on the instruction data object.

In some embodiments, the data architecture comparison apparatus 160 may receive the instruction data object via the network 104 and/or the application framework system 105. In some embodiments, the instruction data object is associated with an API request associated with the one or more client devices 102a-n. In some embodiments, the data architecture comparison apparatus 160 may receive the instruction data object is response to a defined event associated with the application framework 106. The defined event may be associated with an event-based notification, alert, incident, performance degradation events and/or user-reported issues related to the application framework 106. In some embodiments, the data architecture comparison apparatus 160 may transmit the instruction data object to the data architecture model 120 and the enhanced data architecture model 130 to cause generation of the structured data object 304 via the data architecture model 120 and/or generation of the structured data object 308 via the enhanced data architecture model 130. In some embodiments, the instruction data object is received prior to the structured data object 304 and the structured data object 308 being received. In some embodiments, the structured data object 304 and the structured data object 308 include a web API response, an internal API response, an event-based notification response, or another type of response associated with the one or more client devices 102a-n.

In some embodiments, the data architecture comparison apparatus 160 may execute a comparison of the structured data object 304 generated by data architecture model 120 and the structured data object 308 generated by the enhanced data architecture model 130 via the comparison process 310. In some embodiments, the comparison associated with the comparison process 310 is executed in response to the structured data object 304 and the structured data object 308 being received within a defined interval of time. As such, in some embodiments, the comparison associated with the comparison process 310 may be synchronously performed in real time or approximately in real time between the structured data object 304 and the structured data object 308 to enable more efficient processing, a reduced number of computing resources, and/or a reduced number of memory resources by the data architecture comparison apparatus 160 and/or the application framework system 105. In some embodiments, the data architecture comparison apparatus 160 may increase a value of a counter data object in response to the structured data object 304 being received and/or the structured data object 308 being received. In some embodiments, the data architecture comparison apparatus 160 may execute the comparison of the structured data object 304 and the structured data object 308 in response to the value of the counter data object satisfying a defined threshold value.

In some embodiments, the comparison associated with the comparison process 310 utilizes one or more comparison rules to enable evaluating the equivalency of the structured data object 304 and the structured data object 308. In some embodiments, the one or more comparison rules may define a rule for different types of structured data objects. For example, the one or more comparison rules may define a first rule for a first type of structured data object (e.g., a ‘GET’ type structured data object) and a second rule for a second type of structured data object (e.g., a ‘POST’ type structured data object). In some embodiments, the one or more comparison rules may additionally or alternatively define a rule for different types of instruction data objects utilized to generate structured data objects. For example, the one or more comparison rules may define a first rule for a first type of instruction data object and a second rule for a second type of instruction data object. In some embodiments, the one or more comparison rules may additionally or alternatively define a rule for different types of URLs, URL patterns, and/or internal mappings between multiple structured data objects.

In some embodiments, the comparison associated with the comparison process 310 may involve comparison of other data associated with the structured data object 304 and the structured data object 308. For example, the comparison associated with the comparison process 310 may involve comparison of first data associated with the structured data object 304 that is stored in one or more partitions of the application framework 106 and second data associated with the structured data object 308 that is stored in one or more other partitions of the application framework 106. The first data may be generated as a result of the structured data object 304 and/or may be particular data utilized to generate the structured data object 304. Similarly, the second data may be generated as a result of the structured data object 308 and/or may be particular data utilized to generate the structured data object 308. A partition may be a collection of data that is stored in a database, datastore, or the like, of the application framework system 105. In some embodiments, a partition is a data partition or a service partition. In some embodiments, a partition is a logical boundary that defines a collection of data. In some embodiments, a partition may be used to store data or a subset of data associated with a structured data object and/or a service (e.g., a microservice). For example, a partition may store one or more data objects associated with a component of the application framework 106. By way of example, a component storing data may split a large table of data into smaller tables of data, each smaller table containing some subset of the overall data referred to as a partition. In some embodiments, the comparison associated with the comparison process 310 may involve multiple comparisons of the same structured data objects across different versions or partitions of application framework 106.

In some embodiments, the data architecture comparison apparatus 160 may generate, based at least in part on the comparison process 310, the performance monitoring data 312 associated with the enhanced data architecture model 130. In some embodiments, the performance monitoring data 312 may include at least an indication of a type of discrepancy between the structured data object 304 and the structured data object 308. For example, the performance monitoring data 312 may include an indication regarding differing metadata, properties, attributes, content, and/or origins of data between the structured data object 304 and the structured data object 308. In some embodiments, the type of discrepancy may be associated with a structed data object attribute, a partition attribute associated with a structured data object, a technical configuration, an application capability, an application configuration, a metadata attribute, and/or another type of discrepancy. In some embodiments, the performance monitoring data 312 may include a particular type of metadata discrepancy between the structured data object 304 and the structured data object 308, a particular type of data property and/or data formatting discrepancy between the structured data object 304 and the structured data object 308, a particular type of attribute discrepancy between the structured data object 304 and the structured data object 308, a particular type of data content discrepancy between the structured data object 304 and the structured data object 308, a particular type of data origin discrepancy between the structured data object 304 and the structured data object 308, a particular type of discrepancy between first partition data associated with the structured data object 304 and second partition data associated with the structured data object 308, and/or another type of discrepancy between the structured data object 304 and the structured data object 308. In some embodiments, the data architecture comparison apparatus 160 may refine the enhanced data architecture model 130 via the model refinement process 320. For example, the data architecture comparison apparatus 160 may refine the enhanced data architecture model 130 based at least in part on the performance monitoring data 312 during the model refinement process 320 In some embodiments, the data architecture comparison apparatus 160 may identify a performance failure event associated with the comparison of the structured data object 304 and the structured data object 308. In some embodiments, the data architecture comparison apparatus 160 determines one or more performance failure patterns associated with the performance failure event. In some embodiments, the data architecture comparison apparatus 160 identifies one or more features of the enhanced data architecture model 130 that impact the one or more performance failure patterns. In some embodiments, the one or more performance failure patterns correspond to one or more patterns between the structured data object 304 and the structured data object 308 that result in a performance degradation, discrepancy, and/or other difference for the enhanced data architecture model 130 as compared to the data architecture model 120. In some embodiments, the data architecture comparison apparatus 160 refines the enhanced data architecture model 130 based at least in part on the one or more features via the model refinement process 320.

In some embodiments, refinement of the enhanced data architecture model 130 may include modifying a data architecture design pattern of the enhanced data architecture model 130, modifying set of instructions and/or software code associated with the enhanced data architecture model 130, modifying one or more data read operations for the enhanced data architecture model 130 with respect to one or more data partitions of the application framework 106, modifying one or more data write operations for the enhanced data architecture model 130 with respect to one or more data partitions of the application framework 106, modifying one or more create, read, update, and delete (CRUD) operations associated with the application framework 106, modifying a type of decoding operation for processing an instruction data object associated with a structured data object, modifying one or more types of database configurations for a structured data object, updating one or more relationship mappings between applications components of the application framework 106, retraining one or more machine learning models utilized by the enhanced data architecture model 130, fine tuning one or more parameters of one or more machine learning models utilized by the enhanced data architecture model 130, adjusting one or more feature biases for one or more machine learning models utilized by the enhanced data architecture model 130, modifying an automated instruction pipeline for a particular type of instruction data object associated with the application framework, modifying an automated instruction pipeline for a particular type of structured data object generated by the enhanced data architecture model 130, and/or one or more other types of refinements to the enhanced data architecture model 130 to satisfy operational requirements and/or performance criteria for the enhanced data architecture model 130.

In some embodiments, refinement of the enhanced data architecture model 130 may additionally or alternatively include presentation of a visualization via an electronic interface of a client device (e.g., a client device of the one or more client devices 102a-n) to facilitate real-time refinement of the enhanced data architecture model 130. For example, the visualization may include a dashboard that identifies one or more patterns, forecast success rates, and/or monitoring of real-time operation of the enhanced data architecture model 130 based on the performance monitoring data 312. In some embodiments, the visualization may include one or more interface elements, graphical control elements, and/or specially configured interface areas that are configured based on the performance monitoring data 312.

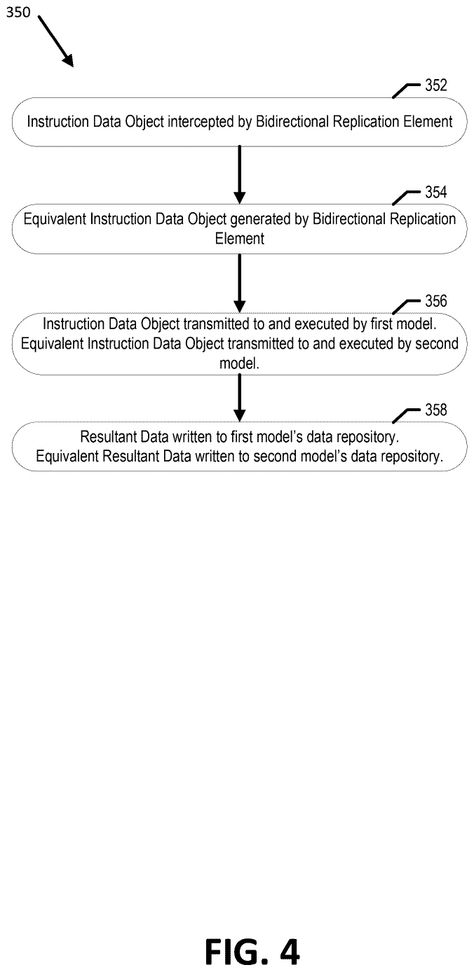

FIG. 4 illustrates an example bidirectional replication mechanism process 350. Bidirectional replication mechanism process 350 may be performed by bidirectional replication element 140. In various embodiments, bidirectional replication element 140 screens incoming data to the data architecture model 120 and enhanced data architecture model 130 to generate equivalent data for transmission to the data architecture model that was not the original intended recipient of the data. This process ensures that both data architecture models are synchronously receiving equivalent data. A first model may be the data architecture model 120. A second model may be the enhanced data architecture model 130.

At operation 352, bidirectional replication element 140 intercepts an instruction data object during its transmission to a first model.

At operation 354, bidirectional replication element 140 generates an equivalent instruction data object based on the instruction data object. The equivalent instruction data object comprises relevant data sourced from the instruction data object intended for receipt by the first model. The equivalent instruction data object is designed, constructed, and formatted in a manner suitable for receipt by a second model. The design, construction, and format of the equivalent instruction data object is intended to enable the second model, upon receipt of the equivalent instruction data object, to perform an equivalent function and produce equivalent output as the first model, upon the first model's receipt of the instruction data object.

At operation 356, bidirectional replication element 140 transmits the instruction data object to the first model for processing and execution of the instruction data object's instructions. Bidirectional replication element 140 transmits the equivalent instruction data object to the second model for processing and execution of the equivalent instruction data object's instructions.

At operation 358, resultant data generated by the first model as a result of processing the instruction data object and executing the instruction data object's instructions is written to a data repository associated with the first model. Equivalent resultant data generated by the second model as a result of processing the equivalent instruction data object and executing the equivalent instruction data object's instructions is written to a data repository associated with the second model.

Bidirectional replication mechanism process 350 ensures that actions, operations, and functions performed by a first model are appropriately and equivalently mirrored by a second model and ensures that a data repository associated with a first model is appropriately and equivalently mirrored by a data repository associated with a second model.

Referring to FIG. 5, an example data flow is presented in accordance with one or more embodiments of the present disclosure. The data flow depicts functionality between various sub-systems of the present disclosure, including bidirectional replication element 140, data architecture model 120, enhanced data architecture model 130, synchronous response comparison circuitry 212, and performance monitoring data 312. One or more portions of the data flow may be executed and/or performed by data architecture comparison apparatus 160.

In various embodiments, bidirectional replication element 140 receives an API request 402. API request 402 is an example of an instruction data object. Upon receipt of API request, bidirectional replication element 140 may perform bidirectional replication mechanism process 350. After processing by bidirectional replication element 140, API request 402 may take the form of both an instruction data object and an equivalent instruction data object. API request 402 is then transmitted to data architecture model 120 and enhanced data architecture model 130. Data architecture model 120 processes API request 402 and generates API response 404. API response 404 is an example of a structured data object. Enhanced data architecture model 130 processes API request 402 and generated API response 406. API response 406 is an example of a structured data object.

In various embodiments, API response 404 and API response 406 are compared by synchronous response comparison circuitry 212. The purpose of comparing the two structured data objects (API response 404 and API response 406) is to determine if the data they contain is equivalent. In this case, equivalency may not be a word-for-word, byte-for-byte identical match. Since the two structured data objects were generated by two different data architecture models, they are designed, constructed, and formatted differently despite being generated in response to equivalent instruction data objects. Synchronous response comparison circuitry 212 evaluates the equivalency of two structured data objects by focusing only on relevant data fields and applying various data filters and value thresholds. For example, due to differing performance speeds of data architecture model 120 and enhanced data architecture model 130, a timestamp data field of API response 404 may differ from a timestamp data field of API response 406. A certain time tolerance threshold must be applied by synchronous response comparison circuitry 212 to accurately discern equivalent structured data objects from inequivalent structured data objects. As another example, due to the differing implementation of data architecture model 120 and enhanced data architecture model 130, equivalent data may be stored in different locations within the structured data objects or may be associated with different key names, such as with a key-value pairing method of data association. Synchronous response comparison circuitry 212 takes these potential differences in structure into account when making a comparison.

In various embodiments, comparison rules may be defined by synchronous response comparison circuitry 212 for evaluating the equivalency of two structured data objects. For example, different comparison rules may be applied by synchronous response comparison circuitry 212 if API response 404 and API response 406 are of type ‘GET’ than if API response 404 and API response 406 are of type ‘POST’. Other factors that influence the application of comparison rules may be request types, URLs, URL patterns, or internal mappings between multiple structured data objects. In some embodiments, the comparison may involve multiple comparisons of the same structured data objects across different versions or partitions of application framework 106.

In various embodiments, as a result of the comparison, synchronous response comparison circuitry 212 generates performance monitoring data 312. Performance monitoring data 312 comprises data indicative of whether the comparison resulted in comparison success or comparison failure. Comparison failure occurs when two structured data objects are deemed inequivalent by synchronous response comparison circuitry 212. Comparison failure is a strong indicator that one or both data architecture models is not operating properly. In the event of a comparison failure, performance monitoring data 312 further comprises data indicative of inequivalent data in the two structured data objects compared, the location of the inequivalent data within the structured data objects, and which sub-system of the data architecture models caused the inequivalence.

Referring now to FIG. 6A and FIG. 6B in tandem, an example data flow is presented in accordance with one or more embodiments of the present disclosure. The data flow depicts functionality between various sub-systems of the present disclosure, including bidirectional replication element 140, data architecture model 120, enhanced data architecture model 130, asynchronous notification queue 510, asynchronous response comparison circuitry 216, and performance monitoring data 312. One or more portions of the data flow may be executed and/or performed by data architecture comparison apparatus 160.

In various embodiments, bidirectional replication element 140 receives an event-based notification 502. Event-based notification 502 is an example of an instruction data entity. Bidirectional replication element 140 may utilize bidirectional replication mechanism process 350 to generate a corresponding event-based notification 504. In FIG. 5A, event-based notification 502 was originally intended for data architecture model 120. Therefore, bidirectional replication element 140 transmits event-based notification 502 to data architecture model 120 and transmits corresponding event-based notification 504 to enhanced data architecture model 130. In FIG. 5B, event-based notification 502 was originally intended for enhanced data architecture model 130. Therefore, bidirectional replication element 140 transmits event-based notification 502 to enhanced data architecture model 130 and transmits corresponding event-based notification 504 to data architecture model 120.

Referring back now to FIG. 6A and FIG. 6B in tandem, data architecture model 120 and enhanced data architecture model 130 receive an event-based notification, process and execute an appropriate operation based on the instructions of the received event-based notification. In doing so, data architecture model 120 generates event-based notification response 506 and microservice model generates event-based notification response 508. Both event-based notification response 506 and event-based notification response 508 are examples of structured data objects. Event-based notification response 506 and event-based notification response 508 are collected and stored in asynchronous notification queue 510.

Due to the asynchronous nature of events (and therefore event-based notifications), event-based notification responses are collected and stored in asynchronous notification queue 510 to wait to be compared by asynchronous response comparison circuitry 216. A periodic bulk comparison 512 occurs to enable event-based notification responses in the asynchronous notification queue 510 to be compared by asynchronous response comparison circuitry 216. A periodic bulk comparison 512 may be triggered for a plurality of reasons, such as the expiration of a timer or the size of the asynchronous notification queue 510 reaching a threshold value.

In various embodiments, event-based notification response 506 and event-based notification response 508 are compared by asynchronous response comparison circuitry 216. The purpose of comparing the two structured data objects (event-based notification response 506 and event-based notification response 508) is to determine if the data they contain is equivalent. In this case, equivalency may not be a word-for-word, byte-for-byte identical match. Since the two structured data objects were generated by two different data architecture models, they are designed, constructed, and formatted differently despite being generated in response to equivalent instruction data objects. Asynchronous response comparison circuitry 216 evaluates the equivalency of two structured data objects by focusing only on relevant data fields and applying various data filters and value thresholds. For example, due to differing performance speeds of data architecture model 120 and enhanced data architecture model 130, a timestamp data field of event-based notification response 506 may differ from a timestamp data field of event-based notification response 508. A certain time tolerance threshold must be applied by asynchronous response comparison circuitry 216 to accurately discern equivalent structured data objects from inequivalent structured data objects. As another example, due to differing implementation of data architecture model 120 and enhanced data architecture model 130, equivalent data may be stored in different locations within the structured data objects or may be associated with different key names, such as with a key-value pairing method of data association. Asynchronous response comparison circuitry 216 takes these potential differences in structure into account when making a comparison.

In various embodiments, comparison rules may be defined by asynchronous response comparison circuitry 216 for evaluating the equivalency of two structured data objects. For example, different comparison rules may be applied by asynchronous response comparison circuitry 216 if API response 404 and API response 406 are of type ‘GET’ than if API response 404 and API response 406 are of type ‘POST’. Other factors that influence the application of comparison rules may be request types, URLs, URL patterns, or internal mappings between multiple structured data objects. In some embodiments, the comparison may involve multiple comparisons of the same structured data objects across different versions or partitions of application framework 106.

In various embodiments, as a result of the comparison, asynchronous response comparison circuitry 216 generates performance monitoring data 312. Performance monitoring data 312 comprises data indicative of whether the comparison resulted in comparison success or comparison failure. Comparison failure occurs when two structured data objects are deemed inequivalent by asynchronous response comparison circuitry 216. Comparison failure is a strong indicator that one or both data architecture models is not operating properly. In the event of a comparison failure, performance monitoring data 312 further comprises data indicative of inequivalent data in the two structured data objects compared, the location of the inequivalent data within the structured data objects, and which sub-system of the data architecture models caused the inequivalence.

Referring to FIG. 7, an example synchronous response monitoring process 600 is presented in accordance with one or more embodiments of the present disclosure. One or more portions of the synchronous response monitoring process 600 may be executed and/or performed by the data architecture comparison apparatus 160.

In various embodiments, synchronous response monitoring process 600 is performed by synchronous response monitoring circuitry 214 to analyze performance monitoring data 312 on a large scale for a plurality of synchronous response comparisons to identify causes of comparison failures and ultimately improve enhanced data architecture model 130 to operate properly and not cause future comparison failures of the same type.

At operation 602, a synchronous response comparison results in comparison failure which generates performance monitoring data 312.

At operation 604, synchronous response monitoring circuitry 214 retrieves the performance monitoring data 312 and includes it in a dataset 608, the dataset 608 comprising a plurality of performance monitoring data.

Operations 602 and 604 are repeated to compile a dataset 608 large enough for the synchronous response monitoring circuitry 214 to perform meaningful analysis.

At operation 606, large scale quantitative analysis of dataset 608 is performed by synchronous response monitoring circuitry 214 to determine inequivalence patterns across a plurality of performance monitoring data 312. In various embodiments, inequivalence patterns may be recognized in structured data entity data fields, metadata, data locations, data properties, data attributes, or the like. Inequivalence patterns may also be recognized in data architecture sub-systems identified by performance monitoring data 312 as the source of a given inequivalence.

In some embodiments, synchronous response monitoring circuitry 214 may generate multiple instances of the same performance monitoring data 312 across multiple versions or partitions of application framework 106 for determining inequivalence patterns.

At operation 610, the enhanced data architecture model 130 is improved, based on the inequivalence patterns analyzed in operation 606, to ensure comparison success in cases which previously resulted in comparison failure. In various embodiments, such improvements may be carried out via software maintenance and debugging processes, revision of data architecture sub-systems, revision of instruction data entity processing, revision of structured data entity design, construction, and formatting, or the like.

Referring to FIG. 8, an example asynchronous response monitoring process 700 is presented in accordance with one or more embodiments of the present disclosure. One or more portions of the asynchronous response monitoring process 700 may be executed and/or performed by the data architecture comparison apparatus 160.

In various embodiments, asynchronous response monitoring process 700 is performed by asynchronous response monitoring circuitry 218 to analyze performance monitoring data on a large scale for a plurality of asynchronous response comparisons to identify causes of comparison failures and ultimately improve enhanced data architecture model 130 to operate properly and not cause future comparison failures of the same type.

At operation 702, a periodic bulk comparison 512 is triggered and a plurality of event-based notifications responses are received by asynchronous response comparison circuitry 216 from asynchronous notification queue 510.

At operation 704, the event-based notification responses are filtered into two lists based on their origin (e.g., a monolith list for originating from data architecture model 120 or a microservice list for originating from enhanced data architecture model 130).

At operation 706, asynchronous response comparison circuitry 216 performs comparisons as described above with respect to FIG. 5A and FIG. 5B.

At operation 708, based on the comparison made in operation 706, a status is assigned to each event-based notification response. Non-limiting examples of statuses include missing from monolith list, missing from microservice list, present in both lists but inequivalent, present in both lists and equivalent. These statuses are utilized in operation 710 to assist in identifying comparison failure patterns.

At operation 710, event-based notification responses bearing a status indicative of comparison failure (such as present in both lists but inequivalent, missing from monolith list, and missing from microservice list) and their associated performance monitoring data 312 is analyzed. Large scale quantitative analysis is performed by asynchronous response monitoring circuitry 218 to determine inequivalence patterns across a plurality of performance monitoring data 312. In various embodiments, inequivalence patterns may be recognized in structured data entity data fields, metadata, data locations, data properties, data attributes, or the like. Inequivalence patterns may also be recognized in data architecture sub-systems identified by performance monitoring data 312 as the source of a given inequivalence.

In some embodiments, asynchronous response monitoring circuitry 218 may generate multiple instances of the same performance monitoring data 312 across multiple versions or partitions of application framework 106 for determining inequivalence patterns.

At operation 712, the enhanced data architecture model 130 is improved, based on the inequivalence patterns analyzed in operation 710, to ensure comparison success in cases which previously resulted in comparison failure. In various embodiments, such improvements may be carried out via software maintenance and debugging processes, revision of data architecture sub-systems, revision of instruction data entity processing, revision of structured data entity design, construction, and formatting, or the like.

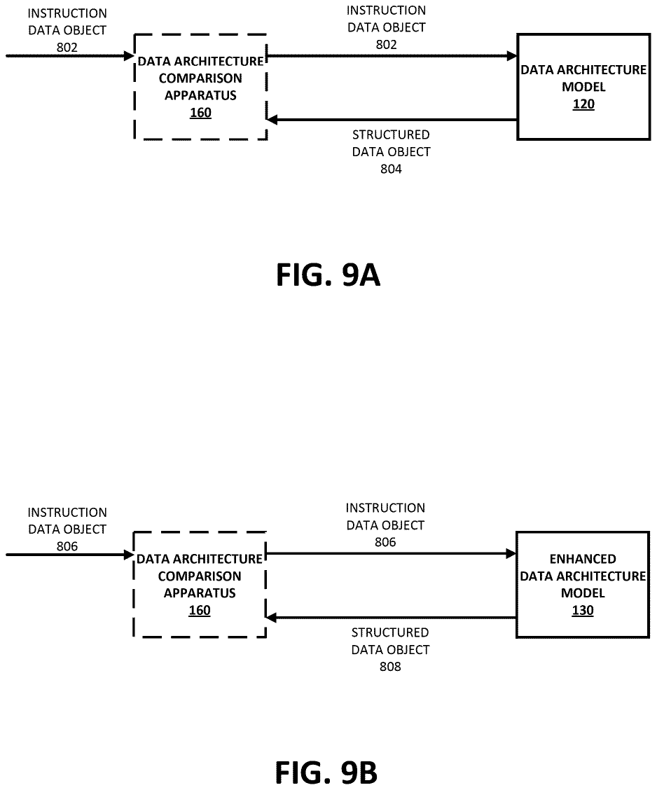

Referring to FIG. 9A, an example data flow is presented in accordance with one or more embodiments of the present disclosure. The data flow depicts functionality between various sub-systems of the present disclosure, including the data architecture comparison apparatus 160 and data architecture model 120. One or more portions of the data flow may be executed and/or performed by the data architecture comparison apparatus 160.

In various embodiments, the data architecture comparison apparatus 160 may access and alter data entering and exiting the data architecture model 120. For example, an incoming instruction data object 802 may be accessed or altered by the data architecture comparison apparatus 160 before being transmitted to data architecture model 120. An outgoing structured data object 804 may be accessed or altered by the data architecture comparison apparatus 160 for the purpose of performing the operations disclosed herein.

Referring to FIG. 9B, an example data flow is presented in accordance with one or more embodiments of the present disclosure. The data flow depicts functionality between various sub-systems of the present disclosure, including the data architecture comparison apparatus 160 and enhanced data architecture model 130. One or more portions of the data flow may be executed and/or performed by the data architecture comparison apparatus 160.

In various embodiments, the application framework system 110 may access and alter data entering and exiting the enhanced data architecture model 130. For example, an incoming instruction data object 806 may be accessed or altered by the data architecture comparison apparatus 160 before being transmitted to enhanced data architecture model 130. In some embodiments, the instruction data object 806 corresponds to the instruction data object 802 received by the data architecture model 120. An outgoing structured data object 808 may be accessed or altered by the data architecture comparison apparatus 160 for the purpose of performing the operations disclosed herein.

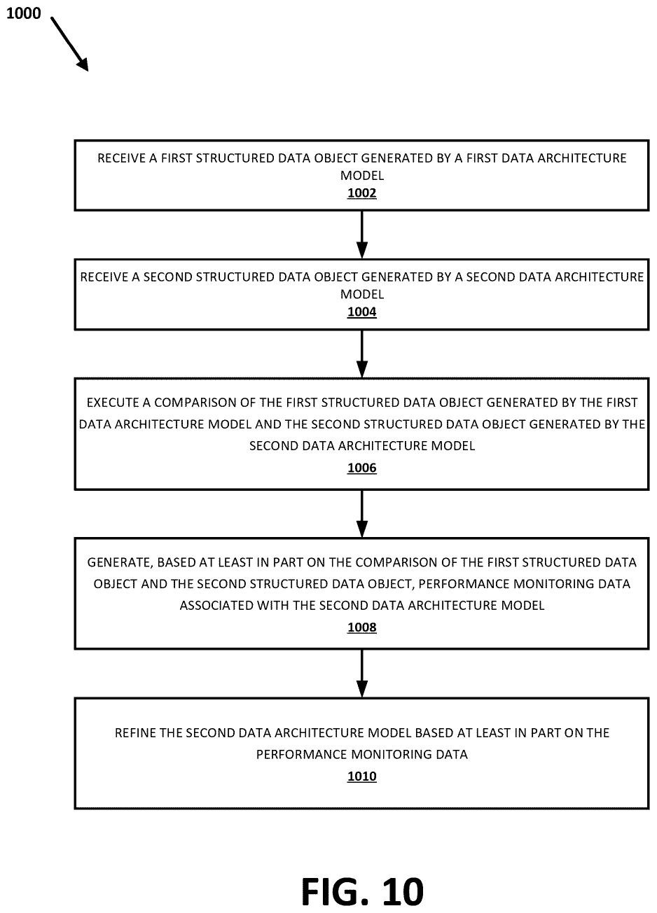

FIG. 10 is a flowchart diagram of an example process 1000 for assessing performance of a data architecture model via an automated comparison framework in accordance with, for example, the data architecture comparison apparatus 160. Via the various operations of process 1000, the data architecture comparison apparatus 160 may enhance performance of the application framework 106 and/or the enhanced data architecture model 130. The process 1000 begins at operation 1002 where a first structured data object generated by a first data architecture model is received. The process 1000 additionally or alternatively includes an operation 1004 that receives a second structured data object generated by a second data architecture model. The process 1000 additionally or alternatively includes an operation 1006 that executes a comparison of the first structured data object generated by the first data architecture model and the second structured data object generated by the second data architecture model. In some embodiments, the comparison is executed in response to the first structured data object and the second structured data object being received within a defined interval of time. The process 1000 additionally or alternatively includes an operation 1008 that generates, based at least in part on the comparison of the first structured data object and the second structured data object, performance monitoring data associated with the second data architecture model. In one or more embodiments, the performance monitoring data comprises at least an indication of a type of discrepancy between the first structured data object and the second structured data object. The process 1000 additionally or alternatively includes an operation 1008 that refines the second data architecture model based at least in part on the performance monitoring data.

In some embodiments, the process 1000 additionally or alternatively includes increasing a value of a counter data object in response to (i) the first structured data object being received, (ii) the second structured data object being received, or (iii) the first structured data object and the second structured data object being received. In some embodiments, the process 1000 additionally or alternatively includes executing the comparison of the first structured data object and the second structured data object in response to the value of the counter data object satisfying a defined threshold value.

In some embodiments, the process 1000 additionally or alternatively includes receiving an instruction data object associated with an application programming interface (API) request. In some embodiments, the process 1000 additionally or alternatively includes transmitting the instruction data object to the first data architecture model and the second data architecture model to cause (i) generation of the first structured data object via the first data architecture model and (ii) generation of the second structured data object via the second data architecture model.

In some embodiments, the instruction data object is received prior to the first structured data object and the second structured data object being received.

In some embodiments, the process 1000 additionally or alternatively includes receiving an instruction data object is response to a defined event associated with an application framework. In some embodiments, the process 1000 additionally or alternatively includes transmitting the instruction data object to the first data architecture model and the second data architecture model to cause (i) generation of the first structured data object via the first data architecture model and (ii) generation of the second structured data object via the second data architecture model.

In some embodiments, the first structured data object and the second structured data object include a web API Response, an internal API response, or an event-based notification response.

In some embodiments, the process 1000 additionally or alternatively includes identifying a performance failure event associated with the comparison of the first structured data object and the second structured data object. In some embodiments, the process 1000 additionally or alternatively includes determining one or more performance failure patterns associated with the performance failure event. In some embodiments, the process 1000 additionally or alternatively includes identifying one or more features of the second data architecture model that impact the one or more performance failure patterns. In some embodiments, the process 1000 additionally or alternatively includes refining the second data architecture model based at least in part on the one or more features.

It should be readily appreciated that the embodiments of the systems and apparatuses, described herein may be configured in various additional and alternative manners in addition to those expressly described herein.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this detailed description has set forth some embodiments of the present invention, the appended claims cover other embodiments of the present invention which differ from the described embodiments according to various modifications and improvements.

Within the appended claims, unless the specific term “means for” or “step for” is used within a given claim, it is not intended that the claim be interpreted under 35 U.S.C. § 112, paragraph 6.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, e.g., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

The operations described herein may be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (Application Specific Integrated Circuit). The apparatus may also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment may realize various different computing model infrastructures, such as web components, web services, web microservices, distributed computing and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described herein may be implemented on a computer having a display device, e.g., a CRT (cathode ray tube) or LCD (liquid crystal display) monitor, for displaying information/data to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's query-initiating computing device in response to requests received from the web browser.

Embodiments of the subject matter described herein may be implemented in a computing system that includes a back-end component, e.g., as an information/data server, or that includes a middleware component, e.g., an application server, or that includes a front-end component, e.g., a query-initiating computing device having a graphical user interface or a web browser through which a user may interact with an implementation of the subject matter described herein, or any combination of one or more such back-end, middleware, or front-end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a query-initiating computing device (e.g., for purposes of displaying information/data to and receiving user input from a user interacting with the query-initiating computing device). Information/data generated at the query-initiating computing device (e.g., a result of the user interaction) may be received from the query-initiating computing device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising one or more processors and one or more storage devices storing instructions that are operable, when executed by the one or more processors, to cause the one or more processors to:
receive a first structured data object generated by a first data architecture model;
receive a second structured data object generated by a second data architecture model;
execute a comparison of first metadata associated with the first structured data object generated by the first data architecture model and second metadata associated with the second structured data object generated by the second data architecture model;
generate, based at least in part on the comparison of the first metadata and the second metadata, performance monitoring data associated with the second data architecture model, wherein the performance monitoring data comprises at least an indication of a type of discrepancy between the first structured data object and the second structured data object; and
refine the second data architecture model based at least in part on the performance monitoring data to generate a refined version of the second data architecture model as compared to the second data architecture model.

2. The apparatus of claim 1, wherein the comparison is executed in response to the first structured data object and the second structured data object being received within a defined interval of time.

3. The apparatus of claim 1, wherein the one or more storage devices store instructions are operable, when executed by the one or more processors, to further cause the one or more processors to:
increase a value of a counter data object in response to (i) the first structured data object being received, (ii) the second structured data object being received, or (iii) the first structured data object and the second structured data object being received; and
execute the comparison of the first structured data object and the second structured data object in response to the value of the counter data object satisfying a defined threshold value.

4. The apparatus of claim 1, wherein the one or more storage devices store instructions are operable, when executed by the one or more processors, to further cause the one or more processors to:
receive an instruction data object associated with an application programming interface (API) request; and
transmit the instruction data object to the first data architecture model and the second data architecture model to cause (i) generation of the first structured data object via the first data architecture model and (ii) generation of the second structured data object via the second data architecture model.

5. The apparatus of claim 4, wherein the instruction data object is received prior to the first structured data object and the second structured data object being received.

6. The apparatus of claim 1, wherein the one or more storage devices store instructions are operable, when executed by the one or more processors, to further cause the one or more processors to:
receive an instruction data object is response to a defined event associated with an application framework; and
transmit the instruction data object to the first data architecture model and the second data architecture model to cause (i) generation of the first structured data object via the first data architecture model and (ii) generation of the second structured data object via the second data architecture model.

7. The apparatus of claim 6, wherein the instruction data object is received prior to the first structured data object and the second structured data object being received.

8. The apparatus of claim 1, wherein the first structured data object and the second structured data object comprise a web API Response, an internal API response, or an event-based notification response.

9. The apparatus of claim 1, wherein the one or more storage devices store instructions are operable, when executed by the one or more processors, to further cause the one or more processors to:
identify a performance failure event associated with the comparison of the first structured data object and the second structured data object;
determine one or more performance failure patterns associated with the performance failure event;
identify one or more features of the second data architecture model that impact the one or more performance failure patterns; and
refine the second data architecture model based at least in part on the one or more features.

10. A computer-implemented method comprising:
receiving a first structured data object generated by a first data architecture model;
receiving a second structured data object generated by a second data architecture model;
executing a comparison of first metadata associated with the first structured data object generated by the first data architecture model and second metadata associated with the second structured data object generated by the second data architecture model;
generating, based at least in part on the comparison of the first metadata and the second metadata, performance monitoring data associated with the second data architecture model; and
refining the second data architecture model based at least in part on the performance monitoring data to generate a refined version of the second data architecture model as compared to the second data architecture model.

11. The computer-implemented method of claim 10, wherein the comparison is executed in response to the first structured data object and the second structured data object being received within a defined interval of time.

12. The computer-implemented method of claim 10, further comprising:
increasing a value of a counter data object in response to (i) the first structured data object being received, (ii) the second structured data object being received, or (iii) the first structured data object and the second structured data object being received; and
executing the comparison of the first structured data object and the second structured data object in response to the value of the counter data object satisfying a defined threshold value.

13. The computer-implemented method of claim 10, further comprising:
receiving an instruction data object associated with an application programming interface (API) request; and
transmitting the instruction data object to the first data architecture model and the second data architecture model to cause (i) generation of the first structured data object via the first data architecture model and (ii) generation of the second structured data object via the second data architecture model.

14. The computer-implemented method of claim 13, wherein the instruction data object is received prior to the first structured data object and the second structured data object being received.

15. The computer-implemented method of claim 10, further comprising:
receiving an instruction data object is response to a defined event associated with an application framework; and
transmitting the instruction data object to the first data architecture model and the second data architecture model to cause (i) generation of the first structured data object via the first data architecture model and (ii) generation of the second structured data object via the second data architecture model.

16. The computer-implemented method of claim 15, wherein the instruction data object is received prior to the first structured data object and the second structured data object being received.

17. The computer-implemented method of claim 10, wherein the first structured data object and the second structured data object comprise a web API Response, an internal API response, or an event-based notification response.

18. The computer-implemented method of claim 10, further comprising:
identifying a performance failure event associated with the comparison of the first structured data object and the second structured data object;
determining one or more performance failure patterns associated with the performance failure event;
identifying one or more features of the second data architecture model that impact the one or more performance failure patterns; and
refining the second data architecture model based at least in part on the one or more features.

19. A computer program product comprising at least one non-transitory computer-readable storage medium having computer-executable program code instructions stored therein, the computer-executable program code instructions comprising program code instructions for:
executing a comparison of first metadata associated with a first structured data object generated by a first data architecture model and second metadata associated with a second structured data object generated by a second data architecture model;
generating, based at least in part on the comparison of the first metadata and the second metadata, performance monitoring data associated with the second data architecture model, wherein the performance monitoring data comprises at least an indication of a type of discrepancy between the first structured data object and the second structured data object; and
refining the second data architecture model based at least in part on the performance monitoring data to generate a refined version of the second data architecture model as compared to the second data architecture model.

20. The computer program product of claim 19, wherein the computer-executable program code instructions further comprise program code instructions for:
identifying a performance failure event associated with the comparison of the first structured data object and the second structured data object;
determining one or more performance failure patterns associated with the performance failure event;
identifying one or more features of the second data architecture model that impact the one or more performance failure patterns; and
refining the second data architecture model based at least in part on the one or more features.
